(19) United States
(12) Patent Application Publication
(10) Pub. No.: US 2023/0211958 A1
(43) Pub. Date: Jul. 6, 2023

(54) CONNECTING DEVICE FOR ASSEMBLING A HOLDER FOR COMPONENTS OF A CONVEYOR DEVICE, AND CONVEYOR DEVICE FOR TRANSPORTING UNIT LOADS

(71) Applicant: TGW Mechanics GmbH, Wels (AT)

(72) Inventors: Stefan LINDORFER, Arnreit (AT); Manuel SCHOENBAUER, Taufkirchen an der Trattnach (AT); Clemens LEEB, Buchkirchen (AT)

(73) Assignee: TGW Mechanics GmbH, Wels (AT)

(21) Appl. No.: 17/927,090

(22) PCT Filed: May 27, 2021
(86) PCT No.: PCT/AT2021/060182

§ 371 Date: Nov. 22, 2022

(30) Foreign Application Priority Data
May 28, 2020 (AT) A 50466/2020

(51) Int. Cl. B65G 41/00

(52) U.S. Cl. CPC B65G 41/006

(57) ABSTRACT

A connecting device for fastening holders, in particular lateral guide holders, to a frame profile of a conveying device for transporting unit loads includes, on one side, a linking arrangement and, on the other side, a mounting limb, wherein the linking arrangement is arranged on the holder and the mounting limb is arranged on the frame profile. For fastening the linking arrangement to the frame profile, the linking arrangement has a connecting element and a locking element, wherein the connecting element is insertable into a first hole on the mounting limb, wherein a rotation axis is defined about which the linking arrangement can be rotated until the locking element latches in a second hole on the mounting limb and locks the connecting device.

The invention relates to a linking arrangement of a connecting device for mounting a holder for components of a conveying device for transporting unit loads, a connecting device, a lateral guidance holder, a sensor holder, and a cover holder according to the preambles of claims 1, 13, 16, 20, and 24.

Moreover, the invention relates to a conveying device according to the preambles of claims 30 and 36, respectively.

Furthermore, the invention relates to a conveying device according to the preamble of claim 40.

From the prior art, holders are known, by means of which lateral guide profiles can be fastened to frame profiles of a conveying device in order to laterally bound a conveying region and to at least temporarily guide unit loads conveyed in the conveying region. Such holders have to have a robust design in order to withstand stresses during an operation of a conveying device and to potentially ensure safety in the case of incorrect use. Thus, the holder is to withstand a weight of a worker, in particular, when said worker steps on a mounted lateral guide profile in order to, for example, perform overhead tasks above the conveying region. In order to fasten the lateral guide profiles to the respective frame profiles, the holders are usually screwed to the frame profile in order to establish a solid and robust connection to the frame profile.

Such a holder is known from DE 101 18 566 A1, which can be mounted laterally on the frame profile. For this purpose, the holder has a connection screw, which interacts with a fastening groove to the side of the frame profile. The lateral guide profile is usually fastened to the frame profile by means of a plurality of such holders, wherein the lateral guide profile is held on the holder by means of a clamping head.

The disadvantage of this is that additional means such as screws are required to affix the holders to the frame profile, which makes mounting the holders complicated. Moreover, the holder is affixed on the side of the frame profile, whereby a subsequent installation of a cover for the frame profile is made more difficult as in each case, parts of the cover have to be mounted between two holders. This results in that a plurality of butt joints, particularly in each case between a part of the cover and a holder fastened to the frame profile, are present along a lateral surface of the frame profile. Furthermore, this results in a significant additional technical expense during installation of the conveying device, especially as each part of the cover has to be precisely adjusted, cut to size, and mounted separately. On the other hand, laterally protruding screws and screw heads entail an increased risk of injury, for example when passing by the conveying device.

Moreover, holders are known from the prior art, by means of which sensors can be fastened to the frame profile of the conveying device. A holder which can be fastened to the frame profile by means of a uniaxial connecting device is described in EP 0 995 980 A2. Here, the holder has a connecting head, which engages with a hole interacting with said connecting head and is fixed by means of a rotation.

The disadvantage of this is that the hole arranged on the frame profile must have a special cross-section that corresponds exactly with the locking head, whereby a production of the frame profile is made difficult. The holes are arranged at selected locations, which is why a sensor position must be taken into account already upon production of the frame profile. Moreover, a uniaxial connecting device is not suitable for mounting lateral guide profiles.

From the prior art, conveying devices are known, in which a light barrier for detecting unit loads in a conveying region is provided. In this regard, the unit load is detected when a light beam of the light barrier is interrupted by the unit load and thus does not impinge on a light receiver of the light barrier.

Normally, such conveying devices have two opposite lateral guide profiles laterally bounding the conveying region, which lateral guide profiles are each fastened to a frame profile. In order to guide a light beam of the light barrier into the conveyor region, usually, a gap between the lateral guide profile and the frame profile is provided.

The disadvantage of this is that especially unit loads, in particular articles packed in so-called polybags, may get caught in the gap, whereby a transport performance of the conveying device is impaired. Moreover, article may be damaged.

In order to overcome this disadvantage, it is known from the prior art that the lateral guide profile connects directly to the frame profile. In order to allow a light beam of the light barrier to be passed into the conveying region, the lateral guide profile has a fractured design, wherein special connecting pieces having a fitting hole for the sensor are inserted between two adjacent parts of the lateral guide profile. The installation of such a conveying device is complicated and complex.

Therefore, it is the object of the invention to specify a linking arrangement of the initially mentioned type, which is universally usable and makes it possible to reduce the amount of work required for mounting a conveying device.

Furthermore, it is the object of the invention to specify a connecting device, a lateral guide holder, a sensor holder, and a cover holder having such a linking arrangement.

Moreover, it is the object of the invention to specify a conveying device of the initially mentioned type, in which the installation effort can be reduced.

Furthermore, it is the object of the invention to specify a conveying device of the initially mentioned type, by means of which any unit load can be transported and reliably detected.

According to the invention, the object of the invention is achieved in a linking arrangement of the initially mentioned type in that the linking arrangement has a base body, which comprises a base wall, a connecting element, and a locking element, wherein the base body provides a mounting surface, and the connecting element is arranged so as to protrude from the mounting surface and, in a linking position of the linking arrangement, can be made to engage with a first hole of the holes, wherein the connecting element forms a mounting axis of rotation with an orthogonal orientation towards the mounting surface, about which mounting axis the linking arrangement can be rotated from the linking position into a mounting position, wherein the locking device is arranged at a distance from the connecting element, such that in the mounting position of the linking arrangement, the locking device can be brought into engagement with a second hole of the holes of the mounting limb.

One advantage achieved by the invention is that the linking arrangement can be connected easily, in particular without screws, to a mounting limb and is universally usable, for example for mounting holders for various components of the conveying device, such as lateral guide profiles, sensors, light reflectors, or covers, in particular bottom covers. It is advantageous that mounting, for example, the holder on the mounting limb can be performed without tools. In this process, the connecting element of the linking arrangement can be inserted from above into the first hole of the holes and, for fastening, can be rotated into the mounting position, in which the locking device engages with the second hole of the holes. Thus, the linking arrangement allows realizing a simple and lockable insertion-and-rotation connection.

Preferably, it is provided that the first hole and the second hole and/or the holes are formed identically.

Fixing, fastening, or the like “from above” refers to, within the meaning of the invention, essentially coming from above the conveying plane.

The mounting limb may be arranged on a frame profile of a conveying device and/or on a cover. In this regard, the longitudinal direction of the mounting limb preferably corresponds with a longitudinal direction of the frame profile and/or the conveying device. The longitudinal direction of the mounting limb, the frame profile and/or the conveying device essentially extends in a conveying direction of the unit load. In curved conveying sections of the conveying device, the longitudinal direction of the mounting limb, the frame profile and/or the conveying device may of course also be curved. Alternatively, the longitudinal direction of the mounting limb extends along a broadside or a longitudinal side of the cover.

Preferably, it is provided that the connecting element has a plug-shaped design. Furthermore, it may be provided that the locking device is configured to automatically engage with the second hole of the holes. Alternatively, the locking device may be formed such that it may be manually brought into engagement with the second hole of the holes.

The base body forms a robust base, which is possibly connected to or formed integrally with the holder.

For mounting the lateral guide profiles or sensors, it may, for example, be provided that the mounting limb is arranged on a frame profile of the conveying device, such that a corresponding holder can be connected to the frame profile from above by means of the linking arrangement in an ergonomically advantageous manner. Furthermore, a work and time effort upon mounting the conveying device is reduced significantly, especially since it is not necessary to screw the linking arrangement to the frame profile and generally, a plurality of holders have to be fixed in conveying devices.

As the holder, for example the lateral guide holder or the sensor holder, are not laterally fastened to the frame profile, it is also possible to install a single-piece lateral cover of the frame profile, in particular a plastic cover, to the frame profile without requiring the lateral cover having to be divided and/or cut into parts. Thereby, mounting the conveying device is additionally simplified. Furthermore, using the single-piece lateral cover and/or lateral cover, a number of butt joints along a lateral surface of the frame profile and/or along a lateral surface of a plurality of frame profiles of a conveying device is reduced significantly, such that cleaning the conveying device is simplified.

For establishing a connection between the linking arrangement and the mounting limb, the linking arrangement is first brought into the linking position, in which the connecting element is inserted into the first hole of the holes. Thereby, the rotation axis defined by the connecting element is positioned and aligned. The linking arrangement is then rotated and/or pivoted about the rotation axis, whereby the linking arrangement is brought out of the linking position into the mounting position. In the mounting position, the locking device is brought into engagement with the second hole of the holes. Thus, the linking arrangement is secured against an inadvertent rotation and/or pivot back into the linking position.

In order to release the connection between the linking arrangement and the mounting limb, the locking device is moved out of the second hole of the holes. The linking arrangement can then be rotated from the mounting position into the linking position, in which the connecting element can be moved out of the first hole of the holes, and, for example, the holder can be removed from the frame profile.

Usefully, the base body has
a top wall,
a first side wall, and
a second side wall,
   wherein the first side wall and the second side wall are arranged so as to be located opposite one another and extend from the base wall at least to the top wall, and wherein an upper side of the base wall is directed towards the top wall, and a bottom side of the base wall provides the mounting surface. Thereby, the base body has a high degree of stability.

Preferably, the base body is formed as a hollow body. Thus, material can be saved, and a weight of the linking arrangement can be reduced. Moreover, the base body may provide an interior and possibly a housing. The top wall and the base wall may be aligned so as to extend in parallel with one another. The holder may be arranged so as to protrude from the upper side of the top wall and/or adjoin the same. For this purpose, the holder may be formed onto the upper side of the top wall. Furthermore, it may be provided that the bottom side of the base wall has a recessed section, in which the connecting element is positioned.

It is favorable if the base body has a plurality of support walls, which are arranged between the first side wall and the second side wall and extend from the base wall to the top wall. The support walls may be aligned in parallel with one another and/or in parallel with the first side wall and/or the second side wall. A first support wall of the support walls is preferably positioned with the connecting element in an imagined line extending orthogonally to the base wall.

Furthermore, a stiffening rib may be provided, which is aligned in parallel with the support walls and formed onto the top wall in the direction towards the base wall. The stiffening rib is possibly positioned with the spring element in an imagined line extending orthogonally to the base wall. Furthermore, a plurality of stiffening ribs may be provided in addition to the support walls or as an alternative to the support walls.

The support walls and/or the stiffening rib increase the flexural rigidity of the top wall, whereby an increased robustness and stability of the linking arrangement is ensured. In addition to the flexural rigidity of the top wall, the support walls also case an increase in a flexural rigidity of the base wall.

Advantageously, the base body has a rear wall, which extends from the base wall at least to the top wall and from the first side wall to the second side wall. Thereby, the base body can be formed to be opened at one side, in particular closed at a rear side and opened at the front side. The rear wall may have a curved design. Preferably, the rear wall extends from the base wall beyond the top wall, in order to form a mounting support of the holder.

If the base body is formed as a hollow body, the base wall, the top wall, the opposing side walls, and the rear wall bound the interior of the hollow body. Usefully, the support walls and/or the support projection are arranged inside the hollow body.

In a preferred embodiment, the base body has five walls, namely the base wall, the top wall, the opposing side walls, and the rear wall, such that the hollow body is open to one side.

Thus, the base body can be produced, in particular including support walls, using a simple injection molding process.

Preferably, the base body is formed from a plastic material. The base body may be produced, preferably as a single piece, using an injection molding process or using 3D printing. Thereby, the base body can be produced particularly economically and simply. Furthermore, the base body has a low weight.

Usefully, it provided that the connecting element comprises a plug having a hammer-shaped head and protruding from the mounting surface at an end protruding from the mounting surface, wherein the hammer-shaped head, in the linking position of the linking arrangement, can be passed through the first hole of the mounting limb and, in the mounting position of the linking arrangement, engages behind an edge region of the first hole of the mounting limb.

Thereby, the connecting element is secured against being pulled out of the first hole of the holes, and the linking arrangement is fixed, orthogonally to the mounting limb, on the mounting limb essentially means of positive engagement. In this regard, a slight clearance between the mounting limb and the hammer-shaped head may be present for facilitating a pivoting movement between the mounting position and the linking position. Preferably, the connecting element is arranged in a torque-proof manner on the base wall, in particular at the bottom side of the base wall.

It is advantageous that the connecting element comprises a stiffening insert.

Thereby, an increased stability and robustness of the linking arrangement, in particular of the connecting element, is achieved. If the linking arrangement is used, for example, for mounting a lateral guide holder of the conveying device, the linking arrangement not only withstands stress due to heavy unit loads, which may laterally bump into and slide along the lateral guide profile, during the operation of the conveying device, but also withstands excessive stress as it may occur due to incorrect use. An incorrect use is given, for example, when an assembly person steps onto the lateral guide profile and the lateral guide holders have to transfer a weight of the assembly person to the frame profile. The stiffening insert may be arranged within the connecting element and/or be at least partially surrounded by the connecting element, for example by molding around the stiffening insert during the production of the linking arrangement by means of injection molding. Advantageously, the head of the connecting element comprises the stiffening insert.

In order to achieve a particularly high degree of robustness, the stiffening insert may be formed of a metal material, in particular steel or aluminum.

Usefully, the connecting element has a recess in which the stiffening insert is arranged and connected to the connecting element. Thereby, on the one hand, the production process is simplified. On the other hand, the robustness of the connecting element can be individually adapted to a respective requirement by inserting different stiffening inserts into the recess.

Furthermore, it may be advantageous if the recess is arranged at the protruding end of the connecting element, in particular at the head of the connecting element. The stiffening inserts may be glued or screwed to the connecting element.

Particularly preferably, the connecting element has a cylindrical screw port, for example a bore, along a longitudinal axis of the connecting element. The screw port may have an internal thread for a screw for fixing the stiffening element. Alternatively, the screw port may be formed having a smooth inner surface and/or no thread. In this case, the connecting element may be fixed using, for example, a self-threading screw, which is screwed into the screw port. Preferably, the screw port reaches through the connecting element into the first support wall of the support walls.

Advantageously, the locking device has a locking element, which is movable perpendicularly to the mounting surface, in particular away from the base body, in order to engage with the second hole of the holes.

In this regard, it may be provided that the base wall has a recess, preferably at its bottom side, wherein the locking element can be moved at least partially, in particular fully into the recess and/or at least partially out of it. The recess may be formed, for example, so as to reach through the base wall, preferably as a passage opening, so that the locking element can be, moved at least partially, in particular fully, into the base wall and/or at least partially away from the base body. Preferably, the locking element is movable into the recess and/or into the base body, such that the locking element is flush with the base wall, in particular with the bottom side of the base wall. Thus, the locking element may be arranged at least partially inside the base body and/or inside the recess in the base wall, in order to move the linking arrangement out of the linking position into the mounting position and vice versa. Equally, the locking element may protrude at least partially away from the base body and/or out of the recess of the base wall, in order to arrest the linking arrangement in the mounting position. It has proven useful that the locking element is formed as a plug.

Preferably, it is provided that the locking element is mounted on the base body so as to be rotatable about a locking axis of rotation, between a first position and a second position, and has a hammer-shaped head, which, in the first position of the locking element, can be passed through the second hole of the holes and, in the second position of the locking element, engages behind an edge region of the second hole of the holes.

Thereby, the locking device can be secured against moving out of the second hole of the holes. Thus, the linking arrangement may be fixed along two axes, namely by means of the connecting element and the locking device, perpendicular to the mounting limb, in particular analogously to the connecting element. This is advantageous particularly when the linking arrangement is connected from the bottom to a mounting limb, as this is the case, for example, when a cover in particular a bottom cover, of a conveying device is fastened. It is not necessary that the first and second position are fixable. Furthermore, it may be provided that the locking element is mounted so as to be rotatable, preferably rotatable by 360°.

It may be preferably provided that the locking element is movable perpendicularly to the mounting surface and against an action of a spring force, wherein, in the mounting position, the locking element can automatically engage with the second hole of the holes, utilizing the spring force.

It is favorable if the locking device comprises a spring element, wherein the locking element is arranged on the spring element. Thus, the locking element is movable against the action of the spring force, in order to prestress the spring such that the locking element can automatically engage with the second hole of the holes upon tension release of the spring element. In this regard, it may be provided that the locking element provides a latch element. The locking element or the latch element may possibly be rotatably mounted on the spring element.

The spring element may be formed, for example, as a spring arm on which the locking element and/or the latch element is arranged. Preferably, the latch element is formed as a locking lug formed onto the spring arm.

As an alternative, the spring element may be arranged in the recess of the base wall. The recess is preferably formed to be cylindrical. In this regard, the spring element may, at a first end, be connected to the base wall. At a second end of the spring element, the locking element may be positioned such that the locking element protrudes at least partially out of the recess when the spring element is relaxed. The locking element thus cooperates with the spring element such that the spring element is tensioned and/or compressed when the locking element is pushed at least partially into the recess.

For example, the latch element and/or the locking element may have a plug-shaped, wedge-shaped, or spherical design and/or be formed as a sphere. Preferably, the spring element is formed as a spiral spring.

Usefully, the base wall has two slots extending from a first edge of the base wall towards a second edge of the base wall opposite the first edge and being spaced apart from one another, so that the base wall can be bent between the slots in order to provide the spring element. A section of the base wall between the slots is thus bendable relative to a remaining section of the base wall and essentially orthogonally to the mounting surface and forms the spring element and/or the spring arm. This allows a movement of the locking and/or latch element, which is arranged on the spring element, so that it can be passed via the mounting limb and can latch into the second hole of the holes. Furthermore, it is favorable if, in this regard, the base body is formed at least partially as a hollow body.

The further object is achieved, according to the invention and utilizing the aforementioned advantages, in that the linking arrangement of a connecting device of the initially mentioned type is formed according to one of the previously mentioned aspects, and the mounting limb has a plurality of holes spaced apart from one another in the longitudinal direction of the mounting limb, wherein a first hole of the holes can interact with the connecting device of the linking arrangement and a second hole of the holes can interact with the locking element of the linking arrangement. Here, the linking arrangement is preferably arranged on the holder.

Thus, the connecting device comprises a first component, namely the linking arrangement, and a second component, namely the mounting limb, wherein the first and second components cooperate in order to establish a connection that can, in particular, be inserted into one another and be locked by means of a rotational movement.

Here, it is particularly provided that the plurality of holes spaced apart from one another in the longitudinal direction of the mounting limb are identically formed. This allows a simplification of the production process of the mounting limb and/or the frame profile.

An advantage achieved by the invention is, above all, that a connection can be established and released again in a simple manner as described above by means of the connecting device, preferably without use of additional tools.

It is advantageous if the mounting limb is arranged on a frame profile of the conveying device.

Thus, the linking arrangement can be easily connected to the frame profile, in order to, for example, mount a holder for a lateral guide profile, a so-called lateral guide holder. The linking arrangement is, in this regard, arranged on the holder and/or comprised by it. For mounting the lateral guide profile on the lateral guide holder, an alternative connecting mechanism, in particular a positive engagement receptacle of the lateral guide profile may be provided on the lateral guide holder, a clamping and/or screwed connection or the like.

It is useful if the mounting limb is arranged on a cover.

The linking arrangement can thereby be easily connected to the cover in order to, for example, connect the cover with a holder for it, a so-called cover holder. The linking arrangement is, in this regard, arranged on the holder and/or comprised by it. In order to fasten the holder to the frame profile, an alternative connecting mechanism may be provided.

Utilizing the aforementioned advantages, the further object is achieved in that, in a lateral guide holder of the initially mentioned type, the linking arrangement is formed according to the previously described aspects.

Within the meaning of the invention, a lateral guide holder comprising a linking arrangement is equal to a linking arrangement comprising a lateral guide holder. These wordings should thus be seen as analogous.

An advantage achieved by the invention should be seen, as presented above, particularly in that the lateral guide holder can be connected to the mounting limb without additional mounting means in an easily accessible manner, namely from above, whereby a lateral guide profile can be fixed to the frame profile in a simple manner.

The lateral profile usually has a guiding side and a mounting side, with the guiding side facing a conveying region and mounting side facing away from a conveying region. The mounting support is formed for receiving the lateral guide profile, particularly the mounting side of the lateral guide profile, in a positive-locking manner. For this purpose, the mounting support of the lateral guide holder and the mounting side of the lateral guide profile may be formed having corresponding contours.

Preferably, the mounting support is formed such that the lateral guide profile can be arranged at a vertical distance from the frame profile. The vertical distance is oriented orthogonally to the mounting limb and extends between the mounting limb of the frame profile and a(n) (imagined) first tangential plane parallel to the mounting limb, which tangential plane defines a lower edge of the lateral guide profile. The vertical distance between the frame profile and the lateral guide profile corresponds to at least a height of the base body of the linking arrangement and/or in other words, to a distance between the bottom side of the base wall and the upper side of the top wall. Thus, an optical access to the conveying region is ensured, which access allows, for example, capturing and/or detecting, by means of optical sensors, unit loads transported in the conveying region. Furthermore, an improved lateral guiding of the unit loads can be achieved with a comparatively low lateral guide profile height. The material usage for the lateral guide profile can be kept low.

Advantageously, the mounting support is formed in a single piece with the base body of the linking arrangement. Thus, the handling of the lateral guide holder is simplified, and its robustness is increased as the lateral guide holder does not have to be additionally connected, possibly using a further connecting mechanism, to the lateral guide profile. Moreover, a simple production is made possible.

Preferably, the mounting support has an opening for receiving the connecting means.

The connecting means can thus be passed through the opening, and the lateral guide profile can be fastened to the lateral guide holder using the connecting means. For this purpose, the opening is preferably formed as a passage bore. Advantageously, the connecting means comprises a screw, which, with a shaft, is passed through the opening, in particular from an outside of the mounting support, and is connected to the lateral guide profile. Alternatively, the screw can be passed through the opening from an inside and be fixed on the outside using a nut. In this regard, the screw head may be connected to the lateral guide profile.

It is preferably provided that the connecting means comprises a hammer-head screw, which may interact with a fastening groove of the lateral guide profile, in order to fasten the lateral guide profile to the lateral guide holder. A hammer-shaped screw head may be received in the fastening groove of the lateral guide profile for fastening, wherein a shaft of the hammer-head screw is passed through the opening of the mounting support and is fixed to the mounting support by means of a nut. For this purpose, the fastening groove is arranged at the mounting side of the lateral guide profile. Preferably, at an open end, the fastening groove has fastening lugs at both sides, so that the fastening groove is formed to reach around and/or engage behind a hammer-shaped head of the hammer-head screw. By tightening the nut, the fastening lugs can be pressed against the mounting support in order to fix the lateral guide profile.

Utilizing the advantages mentioned for the linking arrangement and/or the connecting device, the further object is achieved in that, in a sensor holder of the initially mentioned type, the sensor holder has a linking arrangement according to one of the previously mentioned aspects.

Within the meaning of the invention, a sensor holder comprising a linking arrangement is equal to a linking arrangement comprising a sensor holder. These wordings should thus be seen as analogous.

Usefully, the outer housing has a base wall and a top wall. Furthermore, a first side wall and a second side wall may be provided, which are arranged opposite one another with each of them extending from the base wall to the top wall. Moreover, a rear wall may be present, which extends from the first side wall to the second side wall and from the base wall to the top wall. Here, it may be provided that an upper side of the base wall is oriented towards the top wall, and a bottom side of the base wall provides the mounting surface. The top wall, the base wall, the side walls and/or the rear walls are preferably formed to be a full surface.

It is favorable if the outer housing is designed such that the emitted light beam can be guided out of the outer housing and the reflected light beam into the outer housing. For this purpose, the outer housing may be formed to be open on one side. This can be realized in that the outer housing has no wall on a side facing the conveying region after being mounted on the frame profile of the conveying device. Alternatively, the outer housing may have a fourth side wall, which has at least one opening, so that the sensor, in particular the light source and the light receiver, are optically accessible.

In an alternative embodiment, the outer housing may be formed as a rack and/or the side walls, the base wall and/or the top wall may be formed as a grid.

The inner housing is arranged inside the outer housing and serves to receive the sensor. Due to this, the sensor holder can be used flexibly as different sensors can be received in the inner housing. Thus, for example the inner housing may ‘be adapted to any sensor without the outer housing, a connection between the inner housing and the outer housing and/or the linking arrangement having to be adapted.

In order to capture and/or detect a unit load being transported by means of the conveying device, it is favorable if the sensor holder comprises a sensor. The sensor is preferably formed as an optical sensor comprising a light source and a light receiver. In this regard, the sensor may be designed, for example, for detecting the unit load or for capturing identification markers such as a barcode or QR code.

Advantageously, the sensor is arranged such that a light beam emitted from the light source crosses through the conveying region. For this purpose, it may be provided that the sensor holder is designed and/or attachable to the frame profile such that the sensor is arranged between the mounting limb and the previously described first tangential plane. For this purpose, a height of the outer housing corresponds with the height of the base body of the linking arrangement of the lateral guide holder and/or with an orthogonal distance between the respective base wall and the top wall.

Preferably, it is provided that the base body of the linking arrangement forms the outer housing. Thus, a sensor holder comprising the linking arrangement and/or a linking arrangement comprising the sensor holder can be produced in a simple manner.

The height of the base body of the sensor holder, i.e. an orthogonal distance between the base wall and the top wall, is preferably smaller than or equal to the previously described vertical distance between the frame profile and the lateral guide profile. Thus, an additional advantage can be seen in that the sensor holder can be fastened to the frame profile of the conveying device, even if the lateral guide profiles are already mounted. Likewise, the sensor holder can be released from the frame profile without the lateral guide profiles having to be removed beforehand. Moreover, this also allows replacing, for example, a defect sensor, which simplifies a maintenance of the conveying device.

Usefully, the inner housing is mounted on the outer housing so as to be pivotable, wherein the inclination of the inner housing can be adjusted by means of an adjusting device. Thereby, the adjustability of an angle enclosed by the emitted light beam and the conveying plane is made possible. In order to allow for pivotable mounting, the outer housing may have one bolt receptacle, for example a circular or elliptical opening and/or recess, in particular a bore, in each of the first side wall and the second side wall. The inner housing may have two cylindrical extensions and/or bolts corresponding to the bolt receptacles, which extensions and/or bolts are arranged on and/or formed onto the inner housing, on both sides of a line relative to one another. These bolts are formed such that they can engage with the corresponding bolt receptacle. Thus, the bolts define a pivot axis of the inner housing, which pivot axis is oriented essentially parallel to the base wall and to the top wall of the outer housing. Preferably, the inner housing is releasably fastened in the outer housing. For this, a mounting notch may be provided on both an inner side of the first side wall and the second side wall, which notch leads from an edge of the side wall to the bolt receptacle, in order to guide the bolt from the notch into the bolt receptacle.

The adjusting device preferably comprises a setscrew and a toothing interacting with it, which toothing is arranged on the inner housing, in particular formed onto the inner housing. Preferably, the setscrew is formed as a threaded pin. It is advantageous if the toothing is formed so as to be curved about the pivot axis of the inner housing, so that a continuous engagement of a threading of the setscrew with the toothing of the inner housing is ensured during the pivoting of the inner housing. In order to form the sensor holder with a low height, it may be provided that the setscrew is arranged orthogonally to the base wall and to the top wall of the outer housing, and the toothing is arranged on a rear wall of the inner housing. Preferably, the base wall and/or the top wall have an actuation opening, through which the setscrew can be actuated, for example by means of a screwdriver.

As an alternative, the setscrew may be oriented parallel to the base wall and to the top wall of the outer housing, and the toothing may be arranged on a base wall or top wall of the inner housing. Thereby, the sensor holder may be designed having a small depth. In this regard, the rear wall of the outer housing may have the actuation opening, through which the setscrew may be actuated, for example by means of a screwdriver.

Advantageously, the connecting element of the linking arrangement has a cable channel, so that a cable of the sensor can be passed out of the outer housing through the cable channel Thereby, a power supply of the sensor, in particular via an external power source, or a data exchange between the sensor and a data processing device can be made possible. The cable of the sensor, for example a power cord and/or a data cable, may be passed, via the cable channel, through the connecting element and thus through the first hole of the holes. Here, the cable of the sensor may have a single cable or be formed as a cable harness with multiple cables.

Preferably, the cable channel has a cylindrical design and extends parallel to the longitudinal axis of the connecting element, preferably from the hammer-shaped head of the connecting element, through the base wall and into the outer housing. A side wall of the cylindrical channel may be opened and/or have a gap parallel to the longitudinal axis of the channel over a total length of the channel, such that the cable channel has an essentially C-shaped cross-section. The cable can thus be pressed through the gap, laterally into the cable channel.

Utilizing the aforementioned advantages, the further object is achieved in that, in a cover holder of the initially mentioned type, the linking arrangement is formed according to the previously described aspects.

With such a cover holder, a cover of the conveying device, in particular a bottom cover and/or a conveying device bottom protection, can be fastened to the frame profile of the conveying device. For this purpose, the cover is fastened to the first frame profile of the conveying device on the one side and to the second frame profile of the conveying device on the other side by means of a plurality of cover holders.

Preferably, the mounting support is formed in a single piece with the base body of the linking arrangement. Thereby, an easy-to-handle cover holder is provided, which can first be connected to the cover and then, with a few simple steps, be fastened to the frame profile of the conveying device.

Usefully, the mounting support is connected to the base body of the linking arrangement by means of a hinge connection, so that the mounting support and the base body of the linking arrangement can be pivoted relative to one another. Thereby, the cover can be fastened to the frame profile of the conveying device in a pivotable manner Here, it may be provided that the cover, in a first position, is first connected, by means of a plurality of pivotable cover holders, to the first frame profile of the conveying device along a first edge of the cover and is subsequently pivoted into a second position, in which the cover is connected to the second frame profile of the conveying device along a second edge of the cover by means of a plurality of pivotable or integral cover holders.

Advantageously, the mounting support has an opening for receiving the connecting means. The connecting means can thus be passed through the opening and be fastened to the frame profile. The aspects previously described for the connection between the lateral guide holder and the lateral guide profile and for the connecting means of the lateral guide holder can be analogously applied to a connection between the cover receptacle and the frame profile and/or the connecting means of the cover receptacle.

Likewise, it is particularly preferably provided that the connecting means comprises a hammer-head screw, which may interact with a fastening groove of the frame profile, in order to fasten the cover holder to the frame profile.

Utilizing the previously described advantages, it is preferably provided that the locking device of the linking arrangement has a locking element which is movable perpendicularly to the mounting surface in order to engage with the second hole of the holes, and/or that the locking element is mounted on the base body so as to be reversibly rotatable about a locking axis of rotation out of a first position into a second position and has a hammer-shaped head, which, in the first position of the locking element, can be passed through the second hole of the holes and, in the second position of the locking element, engages behind an edge region of the second hole of the holes.

The further object is achieved, utilizing the aforementioned advantages, in that in a conveying device of the initially mentioned type, at least one lateral guide holder of the lateral guide holders has a linking arrangement according to one of the previously described aspects and is connected to a corresponding frame profile of the frame profiles via a connecting device according to one of the previously described aspects.

An advantage achieved by the invention is, in particular, that the conveying device can be erected in a simple manner, wherein the lateral guide holders can be connected to the mounting limb of the frame profile without having to be screwed together.

The conveying plane, on which a unit load can be transported, is defined by the at least one conveying element. For example, the conveying device may be designed as a belt conveyor, wherein a circulating conveyor belt provides the conveying element, wherein the conveying plane is defined by the conveying belt. As an alternative to this, the conveying device may be designed as a roller conveyor, wherein a plurality of conveying elements, in particular conveying rollers, are provided, wherein the conveying plane is defined by the conveying elements.

In such a conveying device, the first lateral guide profile and the second lateral guide profile form a lateral bounding of the conveying region, in which unit loads can be conveyed. Towards the bottom, the conveying region is bounded by the conveying plane. The unit load is conveyed on the conveying plane.

Usefully, the at least one lateral guide holder of the lateral guide holders is formed according to one of the previously described aspects. Furthermore, additional alternative lateral guide holders may be used.

It is advantageous if the frame profiles each comprise a profile limb oriented orthogonally to the conveying plane, wherein the profile limb has a first side facing the conveying plane and a second side facing away from the conveying plane, and wherein the mounting limb is arranged on the profile limb so as to protrude from the second side and is oriented in parallel with the conveying plane. Preferably, the mounting limb is arranged and oriented in one plane with the conveying plane and/or in parallel with the conveying plane. The frame profile preferably comprises a further limb arranged in parallel to the mounting limb, which further limb is arranged on the profile limb so as to protrude from the second side, so that the frame profile has an essentially C-shaped cross-section. Furthermore, the frame profile may have a removable lateral cover, which extends between the mounting limb and the further limb and is positioned at a distance from the profile limb, so that an interior space is provided, which is limited by the profile limb, the mounting limb, the further limb and the lateral cover. In this interior, for example cables, in particular power cords or data cables, for example of a sensor, may be guided. Particularly preferably, the cable of a sensor is passed through the cable channel of a sensor holder, through the first hole of the holes, into the interior of the frame profile.

Advantageously, the profile limb has a plurality of mounting openings. On a mounting opening of the mounting openings, for example a conveying element or a component, such as a terminal box for an actuator and/or a sensor, a data processing device, a power supply for electrical components, and the like, may be mounted. The conveying element, in particular the conveyor roller, may be mounted in opposite mounting openings of the frame profile by means of a roller axle. As an alternative or in addition thereto, a mounting opening of the mounting openings may serve to guide cables through, such that a cable can be guided from the first side of the profile limb to the second side of the profile limb, in particular into the interior of the profile limb.

Preferably, the lateral guide profiles each have one fastening groove for receiving a connecting means of the lateral guide holders. Thus, a lateral guide profile may be fastened to the lateral guide holders in a simple manner. In this regard, the fastening groove may be designed as previously described regarding the lateral guide holder.

In order to monitor a transport process, it may be provided that at least one sensor is fastened to a frame profile of the frame profiles by means of a sensor holder according to one of the aforementioned aspects. Preferably, the sensor is connected to a control unit, which, dependent on a sensor signal, controls the drive of the conveying element, for example changes the conveying speed of the conveying element of the conveying device on order to stop a unit load in a conveying section on the conveying movement or to transport it at a changed transport speed. For detecting a presence of a unit load in a particular conveying section, the conveying device preferably has a light barrier comprising the sensor. The light barrier may be configured as a through-beam sensor, which comprises one light source and/or one light emitter and one light receiver, each positioned on opposite sides of the conveying section. Alternatively, the light barrier may be configured as a reflective light barrier, wherein the sensor comprises a light source and a light receiver, which are arranged in a shared housing, and wherein the light barrier comprises a light reflector, which is positioned on a side of the conveying region opposite the sensor.

The further object is achieved using a conveying device of the initially mentioned type, wherein at least one cover holder of the cover holders has a linking arrangement according to one of the previously described aspects and is connectable to the cover by means of a connecting device according to one of the previously described aspects, in which the mounting limbs are arranged on the cover, wherein the first edge section of the cover and the second edge section of the cover each form a mounting limb.

Preferably, the cover is configured as a bottom cover and mounted on a bottom side of the conveying device. The bottom cover serves as a protection from intrusion into the conveying device from below. Furthermore, the cover may be lined with a mat, in order to dampen a sound and/or noise of the conveying device.

Using a connecting device and/or a holder with a linking arrangement according to the invention, the cover may be connected to the frame profile of the conveying device in a simple manner. In this regard, it may particularly be provided that the cover holder is first connected to the cover via the linking arrangement and subsequently connected to the frame profile via the connecting means, preferably the hammer-head screw.

Utilizing the aforementioned advantages, the at least one cover holder is formed according to one of the previously described aspects.

Usefully, the frame profiles each have a cover limb oriented parallel to the conveying plane, which cover limb has a fastening groove. The cover limb may essentially correspond with the previously described further limb and extend in parallel with the mounting limb of the frame profile. The fastening groove is formed analogously to the fastening groove of the lateral guide profile, so that the connecting means, in particular the hammer-head screw, of the cover holder can be received in the fastening groove.

Advantageously, the conveying device is configured according to one of the previously described aspects.

According to the invention, the further object is achieved in that, in a conveying device of the initially mentioned type, the first lateral guide profile has a first passage opening, through which the emitted light beam can be passed into the conveying region, and which provides a sensor-side aperture plate for the mitted light beam.

The sensor may thus be positioned behind the lateral guide profile and/or on a side of the lateral guide profile facing away from the conveying region, namely the mounting side, wherein the emitted light beam is passed through the passage opening into the conveying region. An advantage achieved by the invention may thus be considered in that the sensor can be positioned in a very space-saving manner. Furthermore, the sensor is arranged on a side of the first lateral guide profile and/or second lateral guide profile facing away from the conveying region located between the first lateral guide profile and the second lateral guide profile and be mounted such that the lateral guide profile is not interrupted. This allows that the first and/or second lateral guide profile is mountable at a small vertical distance from the frame profile, preferably immediately adjacent to the frame profile, so that the conveying device is suitable for transporting any unit load, in particular articles packed in plastic sacks and/or polybags. For this purpose, the first lateral guide profile and/or the second lateral guide profile may have a skirt, which increases a guide surface of the lateral guide profile directed towards the conveying region and/or which extends below the conveying plane and closes a gap between the lateral guide profile and the frame profile. In this regard, the skirt may comprise an aperture plate. By means of the aperture plate, a transmission taper angle of the emitted light is limited, whereby a sensitivity of the sensor can be increased.

In this manner, significantly more cost-effective sensors can be used, the light sources and/or light emitters of which usually provide a particularly divergent light beam, as a measuring and/or detection inaccuracy caused by the divergent light beam can by essentially compensated by the limited transmission taper angle.

The sensor or the sensors may be mounted on the first frame profile of the conveying device by means of a first embodiment of a sensor holder according to one of the previously described aspects. Alternatively, the sensor or the sensors may be mounted by means of a second embodiment of a sensor holder, which can be laterally fastened to and/or laterally screwed to one of the frame profiles.

Alternatively, the sensor or the sensors may be fastened to the first lateral guide profile by means of a third embodiment of a sensor holder. For this purpose, this sensor holder has a fastening means, in particular a clamping means, which interacts with a fastening groove of the lateral guide profile, in order to fasten said sensor holder to the lateral guide profile. The fastening means may be configured essentially analogously to the mounting section of the previously described lateral guide holder. Furthermore, this sensor holder may have an outer housing, an inner housing, and possibly an adjusting device, which are configured essentially analogously to the outer housing, the inner housing, and possibly the adjusting device of the previously described sensor holder.

Preferably, the conveying device has a light barrier, which comprises the sensor and a light reflector corresponding to the sensor, wherein the sensor has a light receiver, and the light reflector is positioned on a side of the conveying region opposite the sensor, such that the emitted light beam is reflectable on the light reflector, and a reflected light beam can be guided from the light reflector to the light receiver. The sensor is thus formed as a reflective light barrier. Thereby, the light source and the light receiver may be positioned on the same side of the conveying region, in particular in a shared housing. Thus, the advantage results that a wiring of the sensor has to installed only on the first frame profile, while a passive element, namely the light reflector, is arranged on the second frame profile. In this, the light beam is passed through the conveying region, from the sensor to the light reflector essentially as an emitted light beam, and passed through the conveying region back to the sensor as a reflected light beam. In this regard, the light reflector may be fasted to the second frame profile or to the second lateral guide profile.

A unit load transported past the sensor in the conveying direction interrupts the light beam. The interruption is detected by the sensor and transformed into an electrical signal. Thus, a presence of the unit load in a specific section of the conveying device can be captured. A path length traveled by the light beam is essentially doubled by the light reflector, and the light beam is passed through the conveying region twice. A probability that the light beam is passed past the unit load to be detected by means of reflections is reduced thereby, and the sensitivity of the sensor and/or the light barrier is increased.

Usefully, the second lateral guide profile has a second passage opening, through which the emitted light beam can be passed to the light reflector and the reflected light beam into the conveying region, and which passage opening provides a reflector-side aperture plate for the emitted light beam and/or the reflected light beam. Thus, the light reflector may be arranged analogously to the sensor and/or also on a side of the first and/or second lateral guide profile facing away from the conveying region located between the first lateral guide profile and the second lateral guide profile. The reflector-side aperture plate also allows limiting a light cone angle of the impinging light beam impinging on the reflector and/or of the reflected light beam, whereby the sensitivity of the sensor is further increased.

Advantageously, the sensor is adjustable relative to the first passage opening by means of an adjusting device, so that the first passage opening cuts off a part of the emitted light beam. Thereby, the emitted light beam and/or the light cone angle of the emitted light beam can be limited and/or cut in a directed manner, whereby a sensitivity of the sensor is further increased.

Analogously to the sensor and utilizing the aforementioned advantages, it may be provided that the light reflector is adjustable relative to the second passage opening by means of a further adjusting device, so that the second passage opening cuts off a part of the reflected light beam.

It has proven useful that a light axis of the emitted light beam extends offset and/or inclined with respect to a central axis of the first passage opening.

Usefully, it is provided that a light axis of the reflected light beam extends offset and/or inclined with respect to a central axis of the second passage opening. Thereby, an edge region of the emitted light beam and/or of the reflected light beam may be cut off and thus, a light cone may be limited, whereby the sensitivity of the sensor is increased.

It is useful if the conveying device is configured according to one of the previously described aspects.

Further features, advantages, and effects of the invention result from the exemplary embodiment shown in the following. The drawings, to which reference is made, show:

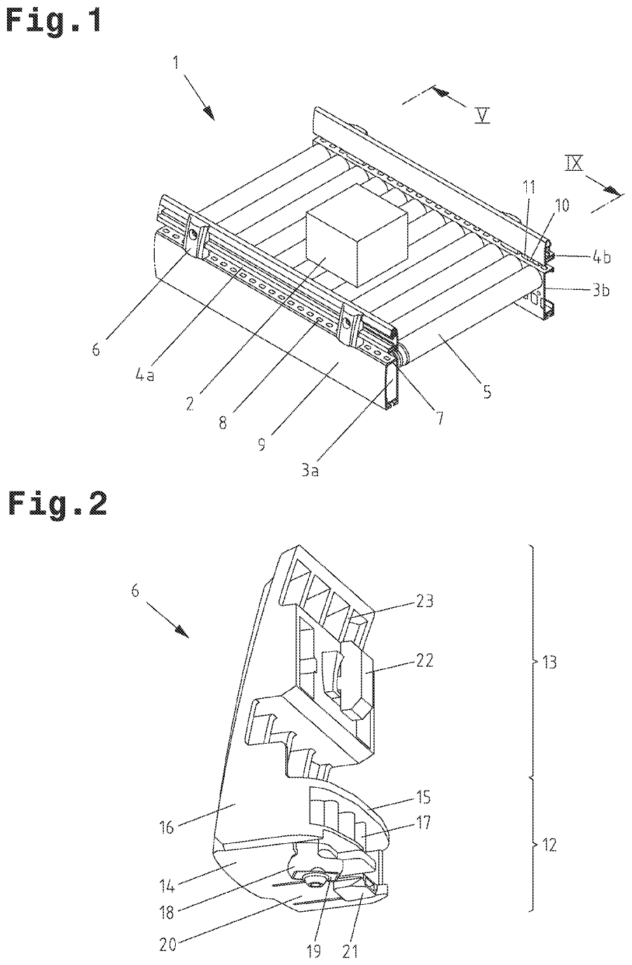

FIG. 1 a section of a conveying device in a first embodiment;

FIG. 2 a lateral guide holder with a linking arrangement;

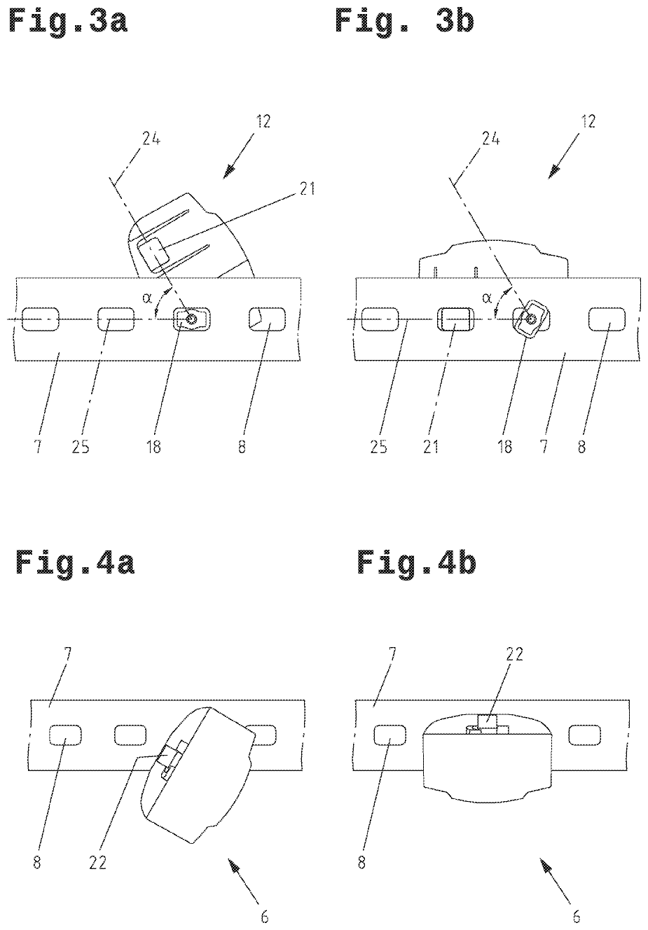

FIG. 3a the linking arrangement in a linking position in a view from below;

FIG. 3b the linking arrangement in a mounting position in a view from below;

FIG. 4a the lateral guide holder in the linking position in a view from above;

FIG. 4b the lateral guide holder in the mounting position in a view from above;

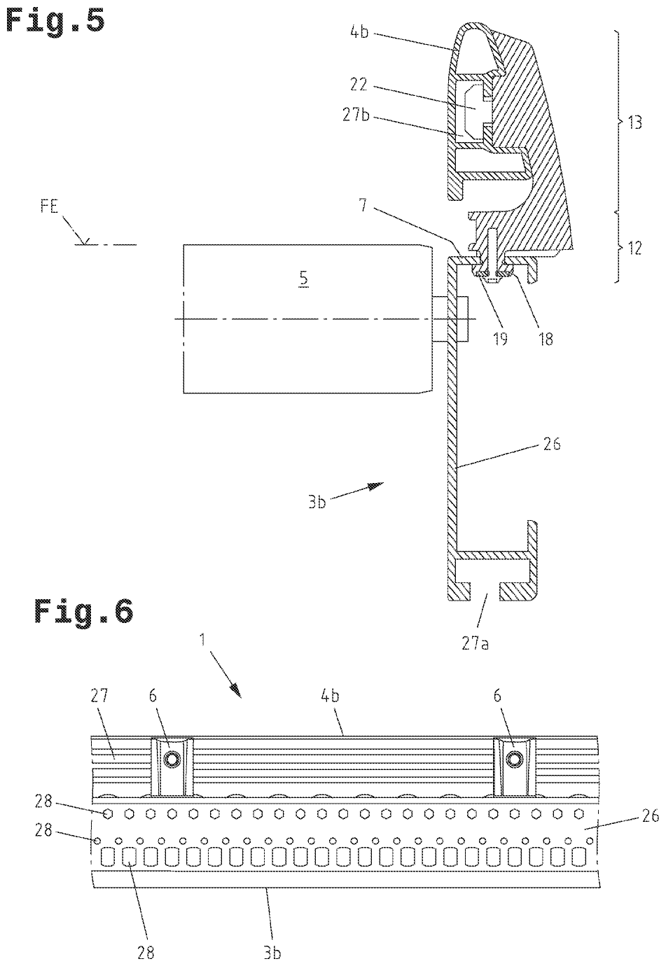

FIG. 5 a cross-section through the conveying device and the lateral guide holder according to V in FIG. 1;

FIG. 6 a lateral view of the conveying device;

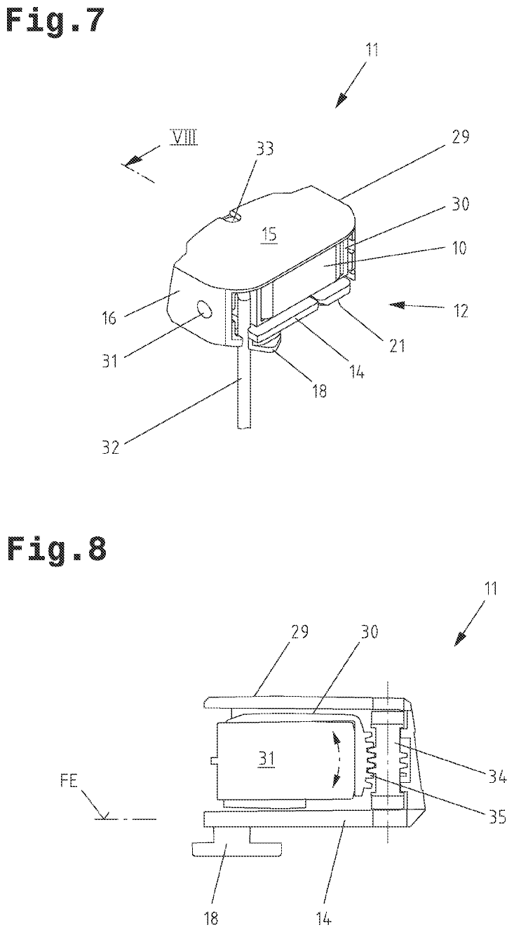

FIG. 7 a sensor holder with the linking arrangement;

FIG. 8 a cross-section through the sensor holder;

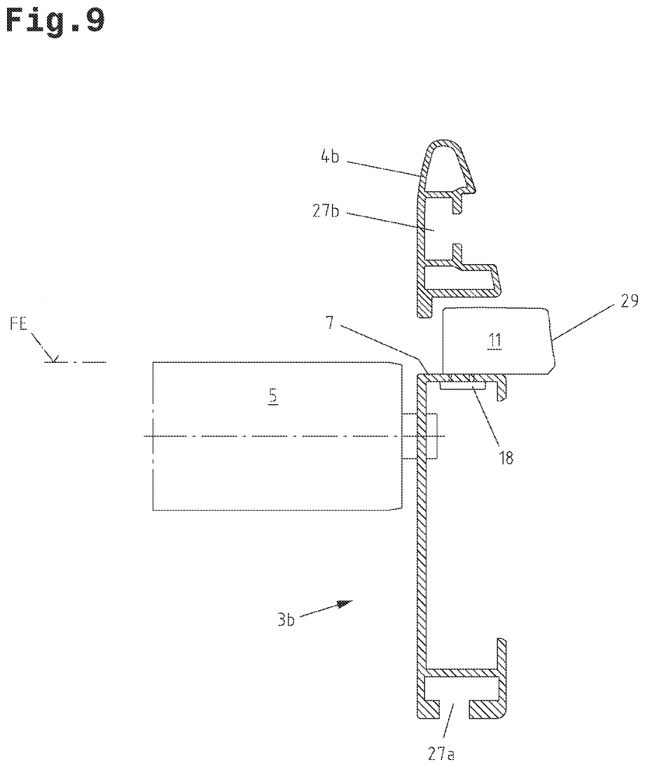

FIG. 9 a cross-section through the conveying device and the sensor holder according to IX in FIG. 1;

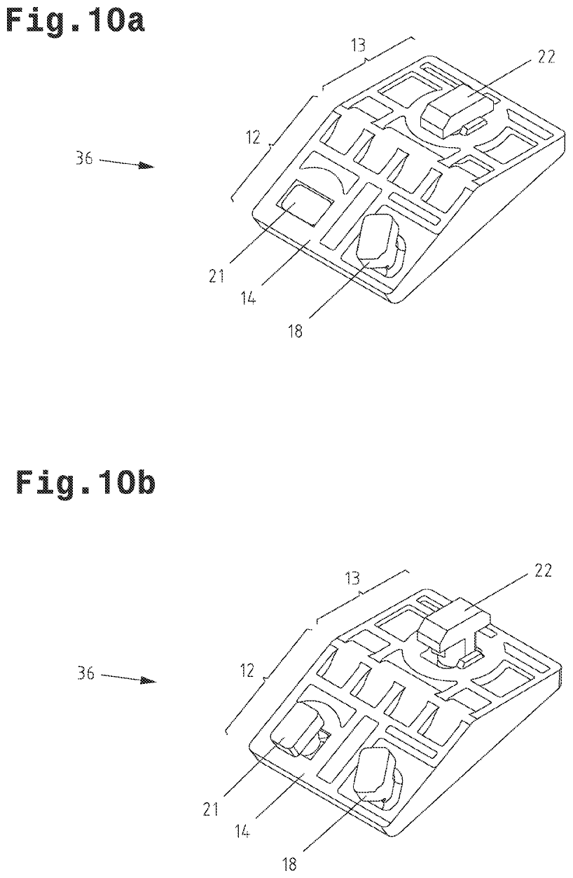

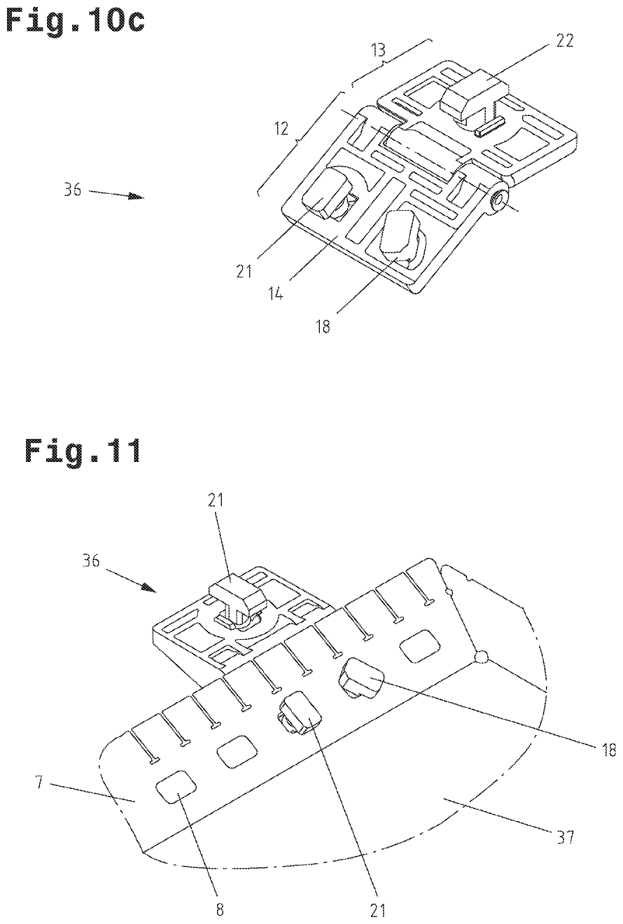

FIG. 10a a first embodiment of a cover holder with the linking arrangement;

FIG. 10b the cover holder according to FIG. 10a in a further representation;

FIG. 10c a second embodiment of the cover holder;

FIG. 11 the cover holder on a cover;

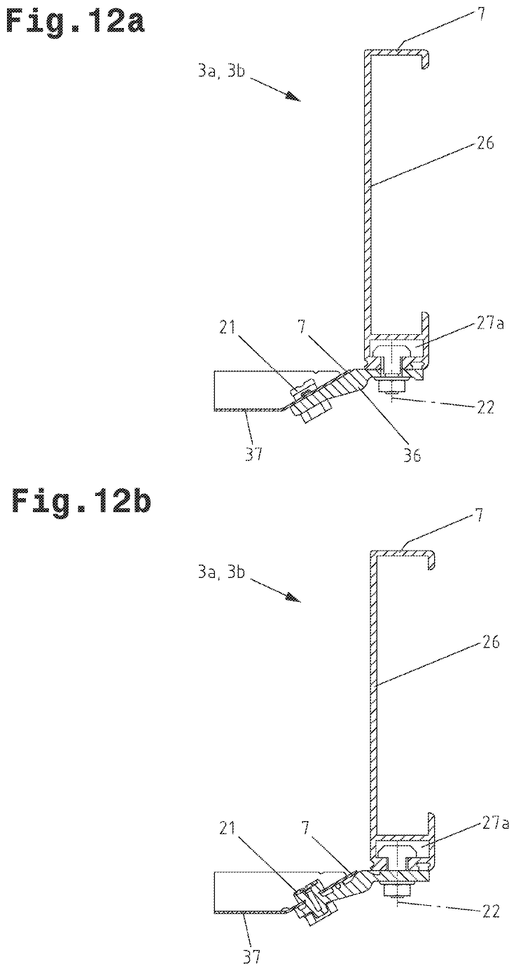

FIG. 12a a cross-section through the fastened cover holder in a first cross-sectional plane;

FIG. 12b a cross-section through the fastened cover holder in a second cross-sectional plane;

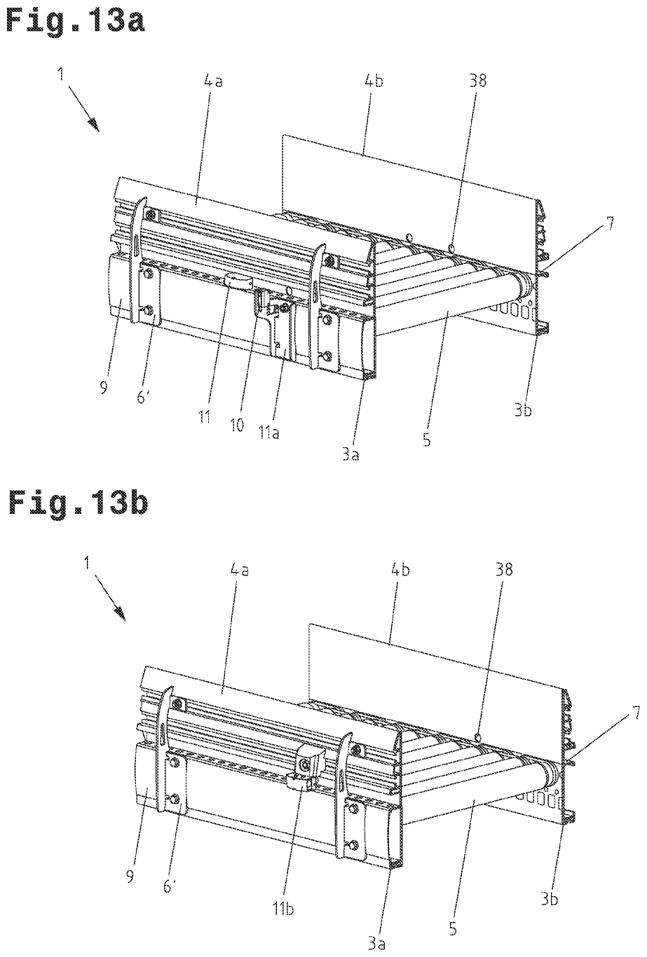

FIG. 13a a section of a conveying device in a second embodiment with a first embodiment of a sensor holder and a second embodiment of a sensor holder;

FIG. 13b the conveying device according to FIG. 13a with a third embodiment of a sensor holder;

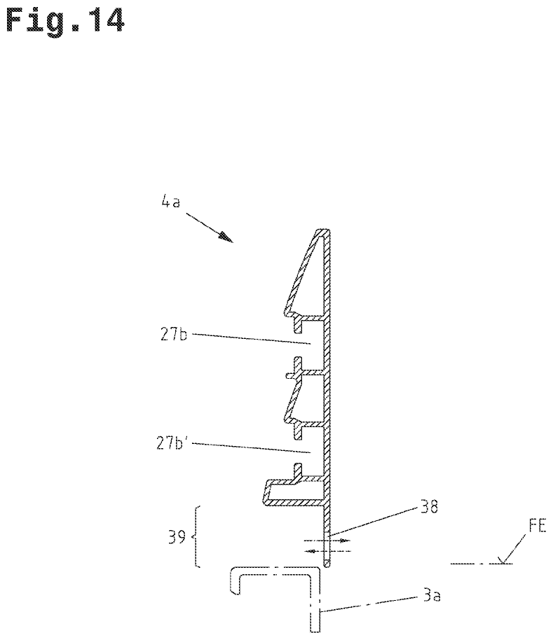

FIG. 14 a cross-section through a lateral guide profile and, schematically adumbrated, the frame profile of the conveying device according to FIG. 13a and FIG. 13b.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, are to be analogously transferred to the new position.

FIG. 1 shows a perspective view of a section of a conveying device 1 for transporting unit loads 2, comprising two frame profiles 3a, 3b, second lateral guide profiles 4a, 4b, and a plurality of conveying elements 5.

In the example shown, a first frame profile 3a and a second frame profile 3b extend parallel to one another at a mutual distance in a conveying direction of the unit load 2. The conveying elements 5 are arranged between the first frame profile 3a and the second frame profile 3b and define a conveying plane.

In this regard, the conveying elements 5 are configured as conveyor rollers. Alternatively thereto, it may be provided that the conveying elements 5 are configured as conveyor belts, or a conveying element 5 is provided which is configured as a conveyor belt. It is also possible that a conveyor belt is guided around conveyor rollers, so that the conveying element 5 is formed by the conveyor belt.

The unit load 2 is transported on the conveying plane FE and/or in a conveying region, which is limited laterally by means of the lateral guide profiles 4a, 4b and/or by inner or guiding sides of the lateral guide profiles 4a, 4b facing one another and limited towards the bottom by the conveying plane FE.

In order to laterally limit the conveying region, a first lateral guide profile 4a and a second lateral guide profile 4b also extend in parallel with one another at a mutual distance and in the conveying direction of the unit load 2. The lateral guide profiles 4a, 4b are each fastened to a corresponding frame profile 3a, 3b by means of a plurality of lateral guide holders 6.

Moreover, the lateral guide profiles 4a, 4b each have a guiding side and a mounting side. In the conveying device 1 shown, the lateral guide profiles 4a, 4b are arranged such that their guiding sides always face one another and/or the conveying region. The mounting side of the first lateral guide profile 4a and the mounting side of the second lateral guide profile 4b face away from one another and/or from the conveying region. Furthermore, the lateral guide profiles 4a, 4b are each connected to the lateral guide holders 6 on the mounting side.

Furthermore, the frame profiles 3a, 3b each have a mounting limb 7, which comprises a plurality of holes 8 spaced apart from one another. For fastening the lateral guide holders 6 to the frame profile 3a, 3b, they are each formed such that the lateral guide holders 6 can engage with the holes 8 of the mounting limbs 7.

The frame profiles 3a, 3b have an essentially C-shaped cross-section, wherein a lateral cover 9 for closing and/or covering an open side of the C-shaped cross-section. Thus, an interior of the frame profile 3a, 3b bounded by the frame profile 3a, 3b and the lateral covers 9 is provided. In FIG. 1, the first frame profile 3a is shown with the lateral cover 9 and the second frame profile 3b is shown without a lateral cover 9.

For detecting the unit load 2, the conveying device 1 has a sensor 10, which is fastened to the second frame profile 3b by means of a sensor holder 11. In this regard, the sensor holder 11 is mounted analogously to the lateral guide holder 6, so that it can engage with the holes 8 in the mounting limb 7.

FIG. 2 shows a perspective representation of a lateral guide holder 6, which comprises a linking arrangement 12 and a mounting support 13. The linking arrangement 12 is arranged on a bottom side of the lateral guide holder 6 and forms, in interaction with the mounting limb 7, in particular with two adjacent holes 8, a connecting device.

In this regard, it is provided that the linking arrangement 12 is arranged on a bottom side of the lateral guide holder 6 and has a base body. The base body comprises a base wall 14, a top wall 15, a rear wall, and two side walls 16. A first side wall 16 and a second side wall 16 are positioned on two opposite ends of the base wall 14 and each extend between the base wall 14 and the top wall 15. The rear wall extends from the first side wall 16 to the second side wall 16 and from the base wall 14 to the top wall 15. Moreover, multiple support walls 17 are provided, which extend parallel to the side walls from the base wall 14 to the top wall 15.

On a side facing away from the top wall 15 and/or a bottom side of the base wall 14, a connecting element 18 and a locking device are arranged. The connecting element 18 and the locking device interact with two adjacent holes 8 in the mounting limb 7 in order to establish a connection, so that the linking arrangement 12 and the mounting limb 7 form a connecting device.

The connecting element 18 comprises a plug with a hammer-shaped head on an end protruding from the base wall 14. For forming the hammer-shaped head, the protruding end is formed having undercuts. The plug is formed onto the base wall 14.

Moreover, the connecting element 18 may comprise a stiffening element 19, which is arranged in a recess on the protruding end of the connecting element 18. The stiffening element 19 may be formed as a platelet, in particular of steel or aluminum. For fixing, the stiffening element 19 can be screwed onto the connecting element 18.

According to this embodiment, the locking device comprises a spring element 20 and a locking element 21, which is arranged on, preferably formed onto, the spring element 20. The spring element 20 may be formed as a spring tongue. Thus, the linking arrangement 12 and the mounting limb 7 form a lockable connecting device.

In the example shown, the locking element 21 is formed as a locking lug. In order to form the spring element 20, the base wall 14 has two slots starting from an edge of the base wall 14, so that the base wall 14 are bendable between said slots. A section of the base wall 14 between the slots thus forms the spring element 20. In this regard, the slots extend in parallel or mirrored around an axis of symmetry to one another, so that the spring element 20 and/or the slots and imagined connecting lines between ends of the slots form a rectangle or an isosceles trapezoid.

It is noted that the linking arrangement 12 shown in FIG. 2 may be arranged on the lateral guide holder 6, or likewise on a holder for further components and parts of the conveying device 1, or may be part of such a holder.

The mounting support 13 is arranged on a side facing away from the base wall 14 and/or upper side of the top wall 15. Furthermore, the mounting support 13 is formed for receiving the lateral guide profile 4a, 4b in a positive-locking manner. For this purpose, the mounting support 13 has a contour corresponding to the mounting side of the lateral guide profile 4a, 4b.

In order to fasten the lateral guide profile 4a, 4b to the mounting support 13 and/or to the lateral guide holder 6, the mounting support 13 has a connecting means 22, which comprises a hammer-head screw in the example shown.

For increasing a dimensional stability and/or a flexural rigidity of the lateral guide holder 6, the mounting support 13 shown has multiple supporting ribs 23, which are arranged essentially orthogonally to the top wall 15. The supporting ribs 23 are not stringently required. Thus, the mounting support 13 may also be formed, for example, as a solid body.

In FIG. 3a and FIG. 3b, a process for establishing a connection between the linking arrangement 12 and the mounting limb 7 in a bottom view.

In the example shown, the holes 8 of the mounting limb 7 are formed as rectangular elongated holes and/or elongated holes with rounded edges. A circumferential shape of the holes 8 is essentially equivalent to a circumferential shape of the hammer-shaped head.

For fastening the linking arrangement 12 to the mounting limb 7, the linking arrangement 12 is first brought into a linking position 24. In the linking position 24, the connecting element 18 is in the same orientation as a first hole 8 of the holes 8. Thus, the hammer-shaped head of the connecting element 18 can be guided through the first hole 8. This is shown in FIG. 3a. The connecting element 18 now introduced into the first hole 8 defines a rotation axis, about which the linking arrangement 12 can be rotated and/or pivoted into a mounting position 25. The rotation axis is oriented perpendicularly to the mounting limb 7. As can be seen in FIG. 3a and FIG. 3b, the holes 8, in particular the first and second hole 8 of the holes 8 have an identical design.

Subsequently, the linking arrangement 12 may be rotated by a specific angle of rotation α, in particular about at least 30°, preferably about an angle in a range of 45° to 90°, particularly preferably about ca. 60°, about the rotation axis into the mounting position 25. FIG. 3b shows the linking arrangement 12 in the mounting position 25.

In the mounting position 25, the hammer-shaped head of the connecting element 18 engages behind the mounting limb 7 in an edge region of the first hole 8. The connecting element 18 is thus secured in the first hole 8 orthogonally to the mounting limb 7 against moving out of it.

During a rotation of the linking arrangement 12 out of the linking position 24 into the mounting position 25, the locking element 21 and the mounting limb 7 interact such that the locking element 21 and the spring element 20 are moved against an action of a spring force, orthogonally to the mounting limb 7 and in the direction of the top wall 15 of the base body and/or upwards. In this process, the spring element 20 is prestressed.

In the mounting position 25, the locking element 21 is positioned above a second hole 8 of the holes 8 and/or in one line with the same, so that the locking element 21 automatically engages with and latches into the second hole 8 upon tension release of the spring element 20. Thereby, the linking arrangement 12 is secured against an inadvertent rotation about the rotation axis, whereby the connecting device is locked.

In an alternative embodiment, it may be provided that the locking element 21 is initially arranged flush or recessed with the base wall 14 and does not automatically latch in the mounting position 25, but rather must be moved and/or pushed through the second hole 8.

In order to release the connection, the locking element 21 will first be moved out of the second hole 8. Then, the linking arrangement 12 can be rotated from the mounting position 25 into the linking position 24, in which the connecting element 18 can be pulled out of the first hole 8 of the holes 8.

An orientation of the linking position 24 and the mounting position 25 as well as the angle of rotation α are each adumbrated by a dot-dashed line in FIG. 3a and FIG. 3b.

FIG. 4a and FIG. 4b show the process, shown generally for the linking arrangement 12 in FIG. 3a and FIG. 3b, for establishing the connection for the linking arrangement 6 in a top view. In this regard, the lateral guide holder 6 is moved out of the linking position 24 (FIG. 4a) into the mounting position 25 (FIG. 4b). The lateral guide holder 6 is formed as shown in FIG. 2, wherein the connecting means 22 of the lateral guide holder 6 can be seen in FIG. 4a and FIG. 4b.

FIG. 5 shows a cross-section through the conveying device 1 along the line V-V in FIG. 1. In this regard, the second lateral guide profile 4b is fastened above the lateral guide profile 6 on the second frame profile 3b. The first lateral guide profile 4a can of course be fastened to the frame profile 3a in an analogous manner by means of a further lateral guide profile 6. The conveying plane FE is oriented orthogonally to the image plane.

Furthermore, the frame profile 3a, 3b comprises a profile limb 26, on which the conveying elements 5 are rotatably mounted by means of a roller axle. The mounting limb 7 of the frame profiles 3a, 3b is arranged so as to orthogonally protrude from the profile limb 26 and directed away from the conveying region and/or from the conveying element 5. Furthermore, the frame profile 3a, 3b comprises a further limb, which is arranged parallel to the mounting limb 7 on one end of the profile limb 26 opposite the mounting limb 7.

The mounting limb 7, the profile limb 26, and the further limb thus essentially form the C-shaped cross-section of the frame profile 3a, 3b. Furthermore, the further limb has a fastening groove 27a directed downwards and/or facing away from the mounting limb 7.

The lateral guide holder 6 can be fastened to the mounting limb 7 of the frame profile 3a, 3b by means of the lateral guide holder 12, in particular as shown in FIG. 3a to FIG. 4b.

FIG. 5 shows the lateral guide holder 6 in a cross-section through the connecting element 18 as well as a first support wall 17, which is arranged in one line with the connecting element 18, so that a fastening screw for the stiffening element 19 can be seen. The fastening screw extends along a longitudinal axis of the connecting element 18. Here, it is provided that the screw projects through the connecting element 18 and through the base wall 14 into the first support wall 17. The connecting element 18 and the first support wall 17 have, for this purpose, a cylindrical bore with an internal thread for the fastening screw.

The lateral guide profile 4a, 4b has a fastening groove 27b on the mounting side, which fastening groove 27b interacts with the connecting means 22, in particular the hammer-head screw, in order to fasten the lateral guide profile 4a, 4b to the lateral guide holder 6.

FIG. 6 shows a side view of the conveying device 1, wherein the lateral guide profile 4b is fastened to the frame profile 3b by means of lateral guide holders 6. Such a construction is equally possible for the first lateral guide profile 4a on the first frame profile 3a and for the second lateral guide profile 4b on the second frame profile 3b, as can be seen in FIG. 1. In this representation, as well, the lateral cover 9 is not shown.

The profile limb 26 of the frame profiles 3a, 3b comprises a plurality of mounting openings 28. It is provided that the conveying elements 5 are mounted in such mounting openings 28, as it is shown in FIG. 5. For this purpose, the roller axle of the conveying elements 5 engages with opposite mounting openings 28 of the first frame profile 3a and the second frame profile 3b.

FIG. 7 shows the sensor holder 11 in a perspective view, wherein the linking arrangement 12 is arranged on a bottom side of the sensor holder 11. The sensor holder 11 is thus fixable to the mounting limb 7 of the frame profile 3a, 3b by means of the linking arrangement 12. A fastening process takes place as described above and shown in FIG. 3a and FIG. 3b.

Here, it is provided that the base body of the linking arrangement 12 provides an outer housing 29 of the sensor holder 11. Inside the outer housing 29, an inner housing 30 is arranged, in which the sensor 10 is positioned.

According to this embodiment, the inner housing 30 is mounted on the outer housing 29 so as to be pivotable. For this purpose, the first side wall 16 and the side wall 16 of the linking arrangement 12 and/or of the outer housing 29 each have a bolt receptacle 31. The bolt receptacle 31 comprises a passage hole, for receiving a bolt, a guide notch, in which the bolt can be guided to the passage hole.

Here, it is provided that one bolt is formed onto each of the opposing side walls of the inner housing 30, each bolt engaging with one bolt receptacle 31. The bolts are oriented in one line relative to one another, such that they define a pivot axis of the inner housing 30, which is oriented in parallel with the base wall 14.

Moreover, the connecting element 18 of the linking arrangement 12 has a cable channel, through which a sensor cable 32 can be guided out of the outer housing 29. The cable channel is formed so as to reach through the connecting element 18 and through the base wall 14 as well as to be cylindrical. In order for the sensor cable 32 to be pressed laterally into the cable channel, the cable channel is opened on one side and/or has a C-shaped cross-section. As the cable channel reaches through the connecting element 18, it is possible to guide the sensor cable 32 through the first hole 8 of the holes 8 into the interior of the frame profile 3a, 3b.

Due to lower stresses acting on the sensor holder 11 than on the lateral guide holder 6, it is not necessary that the base body has multiple support walls and/or the connecting element 18 has a stiffening element 19.

In order to adjust an inclination of the inner housing 30 and thus of the sensor 10 received therein relative to the conveying plane FE, the sensor holder 11 has an adjusting device, which is accessible and actuatable via an actuating opening 33 in the top wall 15 and/or in the base wall 14.

FIG. 8 shows a cross-section along the line VIII-VIII, shown in FIG. 7, through the sensor holder 11, wherein the adjusting device inside the outer housing 29 can be seen.

The adjusting device comprises a setscrew 34 and a toothing 35 interacting therewith, which toothing 35 is arranged on the inner housing 30. In the example shown, the setscrew 34 is oriented orthogonally to the base wall 14, and the toothing 35 is curved about the pivot axis of the inner housing 30. By actuating and/or rotating the setscrew 34, the inner housing 30 and thus the sensor 10 can be pivoted about the pivot axis, as adumbrated by the double arrow. The setscrew 34 may be actuated through the actuating opening 33 in the top wall 15, for example using a screwdriver.

FIG. 9 shows a cross-section through the conveying device 1 along the line IX-IX in FIG. 1. Here, the sensor holder 11 is fastened to the mounting limb 7 of the second frame profile 3b, so that the outer housing 29 is essentially positioned between the second frame profile 3b and the second lateral guide profile 4b. Of course, the sensor holder 11 may be fastened to the first frame profile 3a in an analogous manner.

In this regard, the lateral guide profile 4a, 4b is arranged, as in FIG. 5, so that a vertical distance between the mounting limb 7 and a lower edge of the lateral guide profile 4a, 4b and/or a tangential plane is provided by the lower edge of the lateral guide profile 4a, 4b. The vertical distance allow an optical connection between the sensor 10 and the conveying region.

FIG. 10a shows a perspective representation of a cover holder 36, by means of which a cover 37, in particular a bottom cover for the conveying device 1, can be affixed to the frame profile 3a, 3b. The cover holder 36 has a further embodiment of the linking arrangement 12.

Likewise, as in the examples shown above, the mounting support 13 comprises a connecting means 22 formed as a hammer-head screw.

The base body has a base wall 14, on which the connecting element 18 is arranged. The connecting element 18 is formed analogously to the previously shown exemplary embodiments of the linking arrangement 12. The stiffening element 19 is not absolutely necessary for the cover holder 36.

In this variant, the locking device comprises a recess in the base wall 14. The locking element 21 is arranged in the recess so as to be displaceable orthogonally to the base wall 14, so that the locking element 21 can be moved out of the recess. Moreover, the locking element 21 is mounted rotatably about a locking axis. The locking axis of rotation is oriented orthogonally to the base wall 14. In this regard, it is provided that the locking element 21 is flush with the base wall 14 or is arranged so as to be recessed from the base wall 14 when the locking element 21 is positioned inside the recess.

FIG. 10b shows the linking arrangement 12 of FIG. 10a, wherein the locking element 21 is rotated out of the recess by 90°. The locking element 21 is, as described above for the connecting element 18, formed having a hammer-shaped head.

The mounting support 13 and the base body of the cover holder 36 shown in FIG. 10a and FIG. 10b are rigidly connected and/or formed as one piece.

FIG. 10c shows an alternative embodiment of the cover holder 36, in which the mounting support 13 and the base body are connected to one another in an articulated manner, in particular via a hinge, in a pivotable manner Thereby, the cover 37 may be fastened to the frame profile 3a, 3b in a pivotable manner.

Fastening the linking arrangement 12 and/or the cover holder 36 to a mounting limb 7 takes place essentially as shown in FIG. 3a and FIG. 3b and as described above.

For fastening, the cover holder 36 and/or the linking arrangement 12 is first brought into the linking position 24, as shown in FIG. 3a, in which the head of the connecting element 18 is guided through the first hole 8 of the holes 8 of the mounting limb 7. Subsequently, the linking arrangement 12 is rotated by the angle of rotation α into the mounting position 25.

In the mounting position 25 of the linking arrangement 12, the locking element 21 can now, as can be seen in FIG. 11, be moved out of the recess and, analogously to the connecting element 18, be brought into engagement with the second hole 8 of the holes 8. Here, a head of the locking element 21 is passed through the second hole 8 of the holes 8.

Subsequently, the locking element 21 can be rotated, in particular by 90°, so that the hammer-shaped head of the locking element 21 engages behind the mounting limb 7 in an edge region of the second hole 8, in a similar manner to the head of the connecting element 18. This is shown in FIG. 11.

In this regard, the mounting limb 7 is arranged on a cover 37. A first edge region of the cover 37 and a second edge region of the cover 37 each form one mounting limb 7. The cover 37 may, for example, be formed as a bottom cover of a conveying device 1, which is fastened to the further limb and/or to a cover limb of the frame profile 3a, 3b by means of the cover holder 36.

FIG. 12a shows a cross-section through the cover holder 36, by means of which the cover 37 is fastened to the frame profile 3a, 3b. The cover 37 and/or the mounting limb 7 of the cover 37 is fastened to the cover holder 36 by means of the linking arrangement 12. The connecting means 22 of the cover holder 36 is inserted into the fastening groove 27a on the further limb and/or on the cover limb of the frame profile 3a, 3b and interacts with it, in order to fasten the cover holder 36 to the frame profile 3a, 3b.

FIG. 12b shows a further cross-section through the cover holder 36 in a plane through the locking element 21, which is rotatably and displaceably mounted to the base body of the linking arrangement 12.

FIG. 13a shows a section of an alternative embodiment of the conveying device 1 in a perspective representation. The conveying device 1 is designed essentially analogously to the conveying device 1 shown in FIG. 1.

In the example shown, a first frame profile 3a and a second frame profile 3b extend parallel to one another at a mutual distance in a conveying direction of the unit load 2 (not depicted).

Between the first frame profile 3a and the second frame profile 3b, a plurality of conveying elements 5 is arranged, which define a conveying plane FE.

In this regard, the conveying elements 5 are configured as conveyor rollers. Alternatively thereto, it may be provided that the conveying elements 5 are configured as conveyor belts, or a conveying element 5 is provided which is configured as a conveyor belt. It is also possible that a conveyor belt is guided around conveyor rollers, so that the conveying element 5 is formed by the conveyor belt.

The unit load 2 is transported on the conveying plane FE and/or in a conveying region, which is limited laterally by means of the lateral guide profiles 4a, 4b and/or by inner or guiding sides of the lateral guide profiles 4a, 4b facing one another and limited towards the bottom by the conveying plane FE.

In order to laterally limit the conveying region, a first lateral guide profile 4a and a second lateral guide profile 4b also extend in parallel with one another at a mutual distance and in the conveying direction of the unit load 2.

The first lateral guide profile 4a is mounted on the first frame profile 3a and the second lateral guide profile 4b is mounted on the second frame profile 3b. The lateral guide profiles 4a, 4b are each fastened to the corresponding frame profile 3a, 3b by means of lateral guide holders. In the embodiment shown, the lateral guide profiles 4a, 4b are mounted using alternative lateral guide holders 6′ alternative to the lateral guide holders described above, which are fastened to the side of the frame profile 3a, 3b. Generally, it would also be conceivable to use lateral guide holders with the linking arrangement 12 described above.

In the example shown, lateral guide profiles 4a, 4b are provided, which essentially directly adjoin the respective frame profile 3a, 3b. Thereby, the conveying device 1 is suitable for transporting unit loads 2 packed in so-called polybags.

Moreover, the lateral guide profiles 4a, 4b each have a guiding side and a mounting side. In the conveying device 1 shown, the lateral guide profiles 4a, 4b are arranged such that their guiding sides always face one another and/or the conveying region. The mounting side of the first lateral guide profile 4a and the mounting side of the second lateral guide profile 4b face away from one another and/or from the conveying region. Furthermore, the lateral guide profiles 4a, 4b are each ‘connected to the lateral guide holders 6’ on the mounting side.

The frame profiles 3a, 3b have an essentially C-shaped cross-section, wherein a lateral cover 9 for closing and/or covering an open side of the C-shaped cross-section. Thus, an interior of the frame profile 3a, 3b bounded by the frame profile 3a, 3b and the lateral covers 9 is provided. In FIG. 13, the first frame profile 3a is shown with the lateral cover 9 and the second frame profile 3b is shown without a lateral cover 9.

For receiving holders, the frame profiles 3a, 3b each have a mounting limb 7, which comprises a plurality of holes 8 spaced apart from one another, as described above.

For detecting a transported unit load 2, the conveying device 1 has one or multiple light barriers, in particular reflective light barriers. In the section of the conveying device 1 shown, two light barriers are arranged. Of course, further light barriers and/or additional sensors 10 may be arranged in sections that are not shown.

Such a light barrier comprises a sensor 10 and a light reflector corresponding to the sensor 10, which is not shown in FIG. 13. The sensor 10 is, in each case, fastened to the first frame profile 3a. The light reflector is mounted opposite the sensor 10, on the second frame profile 3b or on the second lateral guide profile 4b.

In the example shown, a sensor 10 (not shown) of a first light barrier is fastened by means of a first sensor holder 11, which has a linking arrangement 12 as described above. A shown sensor 10 of a second light barrier is mounted by means of an alternative sensor holder 11a, which is fastened to the side of the frame profile 3a, 3b. Usually, sensors 10 may be mounted by means of the first sensor holder 11 or the alternative sensor holder 11a.

In a variant shown in FIG. 13b, the sensor 10 (not shown) may be mounted by means of a further alternative sensor holder 11b, which is fastened to the first lateral guide profile 4a. The further alternative sensor holder 11b has an outer housing 29 and an inner housing 30 for receiving the sensor 10, as shown in FIG. 7 and FIG. 8. The inner housing 30 is (as described above regarding FIG. 7 and FIG. 8) pivotably mounted on the outer housing 29. An inclination of the inner housing 30 and/or of the sensor 10 may be adjusted according to an adjusting device as described above regarding FIG. 7 and FIG. 8. In contrast to the embodiment shown in FIG. 8, the outer housing 29 shown in FIG. 13b has no connecting element 18 as well as no locking element 21.

Furthermore, the sensor holder 11b comprises an alternative linking arrangement having a fastening means and/or clamping means, which interacts with the upper fastening groove 27b indicated in FIG. 14 or with the lower fastening groove 27b′, as it is shown in FIG. 13b. The alternative linking arrangement may be formed essentially analogously to the mounting section 13 of the lateral guide holder 6.

The sensor 10 comprises a light source and/or a light emitter for providing an emitted light beam (cf. arrow in solid line in FIG. 14) and a light receiver for capturing a light beam. In the light barrier shown, the emitted light beam is passed from the light source to the light reflector, wherein the emitted light beam crosses through the conveying region. A light beam reflected at the light reflector (cf. Arrow in dashed line in FIG. 14) is passed from the light reflector to the light receiver, wherein the reflected light beam crosses through the conveying region.

In order to allow guiding the emitted light beam and/or the reflected light beam through, the first lateral guide profile 4a has a first passage opening 38 and the second lateral guide profile 4b has a second passage opening 38, which provide a sensor-side aperture plate and a reflector-side aperture plate. Here, it is provided that each sensor 10 and/or each reflector is assigned an aperture plate of the aperture plates.

Furthermore, the sensor 10 is adjustable relative to the sensor-side aperture plate by means of an adjusting device, such that an angle between a central axis of the passage opening 38 and the emitted light beam can be adjusted. Moreover, it is provided that the sensor 10 is positioned relative to the passage opening 38 such that a part of the light beam is cut off by the passage opening 38. In this regard, the light beam extends offset to the central axis of the passage opening 38. The light reflector may be adjustable in the same manner, so that an angle between a central axis of the second passage opening 38 and the reflected light beam can be adjusted.

FIG. 14 shows a cross-section through the first lateral guide profile 4a and, schematically adumbrated, the first frame profile 3a of the alternative conveying device 1, which has a first and/or upper fastening groove 27b and a second and/or lower fastening groove 27b′. The first lateral guide profile 4a thus has a greater height and/or a greater distance between a lower edge and an upper edge of the lateral guide profile 4a as compared to the lateral guide profile shown in cross-section in FIG. 5 and FIG. 9. Thereby, a gap and/or a vertical distance between the lateral guide profile 4a and the frame profile 3a, 3b can be closed and/or reduced. The second lateral guide profile 4b may be formed in the same manner and be analogously arranged on the second frame profile 3b.

The lateral guide profiles 4a, 4b can be arranged such that a lower edge of the respective lateral guide profile 4a, 4b extends below the conveying plane FE, as shown in FIG. 14. In other words, the conveying plane FE may extend, in particular slightly, above a lower edge of the lateral guide profile 4a, 4b, as indicated in FIG. 14.

For fastening said lateral guide profile 4a, 4b, the lateral guide holder 6′ engages with the upper fastening groove 27b, as can be seen in FIG. 13. At the lower end, the lateral guide profile 4a, 4b has a skirt 39 for closing and/or covering a gap and/or vertical distance, as can be seen in FIG. 1, between the lateral guide profile 4a, 4b and the frame profile 3a, 3b, as is shown in FIG. 14.

The passage opening 38 is arranged in the skirt 39 in order to guide the emitted light beam and/or the reflected light beam just above the conveying plane FE into the conveying region. In this regard, the passage opening 38 and/or the aperture plate may be drilled or punched.

Finally, it should be noted that using the linking arrangement 12 described, a robust and lockable connecting device can be realized, by means of which a variety of holders for conveying device components, such as lateral guide profiles 4a, 4b, connecting elements 18, sensors 10, reflectors, covers 37, in particular bottom covers, and the like, can be fastened to the frame profile 3a, 3b of the conveying device 1. Such holders can therefore be embodied as lateral guide holders 6, sensor holders 11, and cover holders 36, for example.

The connecting device according to the invention can thus be used universally and in a simple manner and simplifies mounting work on the conveying device 1. Furthermore, a field of application of the conveying device 1 can be expanded by means of the passage opening 38.

Finally, it should also be noted that the scope of protection is determined by the claims. Nevertheless, the description and drawings are to be used for construing the claims.

In particular, it should also be noted that the devices shown may in reality comprise more or fewer components than those shown. In some cases, the shown devices and/or their components may not be depicted to scale and/or be enlarged and/or reduced in size.

List of reference numbers

| | |
|---|---|
| 1 | Conveying device |
| 2 | Unit load |
| 3a, 3b | Frame profile |
| 4a, 4b | Lateral guide profile |
| 5 | Conveying element |
| 6 | Lateral guide holder |
| 7 | Mounting limb |
| 8 | Hole |
| 9 | Lateral cover |
| 10 | Sensor |
| 11 | Sensor holder |
| 11a, 11b | Alternative sensor holders |
| 12 | Linking arrangement |
| 13 | Mounting support |
| 14 | Base wall |
| 15 | Top wall |
| 16 | Side wall |
| 17 | Support wall |
| 18 | Connecting element |
| 19 | Stiffening element |
| 20 | Spring element |
| 21 | Locking element |
| 22 | Connecting means |
| 23 | Supporting ribs |
| 24 | Linking position |
| 25 | Mounting position |
| 26 | Profile limb |
| 27 | Fastening groove |
| 28 | Mounting opening |
| 29 | Outer housing |
| 30 | Inner housing |
| 31 | Bolt receptacle |
| 32 | Sensor cable |
| 33 | Actuating opening |
| 34 | Setscrew |
| 35 | Toothing |
| 36 | Cover holder |
| 37 | Cover |
| 38 | Passage opening |
| 39 | Skirt |
| α | Angle of rotation |

1: A linking arrangement (12) of a connecting device for mounting a holder for components of a conveying device (1) for transporting unit loads (2), in particular of a lateral guide holder (6), a sensor holder (11), or a bottom cover holder, wherein the linking arrangement (12) arrangeable on the holder and is connectable to a mounting limb (7), which has a plurality of holes (8) arranged at a distance from one another in a longitudinal direction of the mounting limb (7), wherein the linking arrangement (12) has a base body, which comprises a base wall (14), a connecting element (18), and a locking device, wherein the base wall (14) provides a mounting surface, and the connecting element (18) is arranged so as to protrude from the mounting surface and can be brought into engagement with a first hole (8) of the holes (8) when the linking arrangement (12) is in a linking position (24), wherein the connecting element (18) forms a mounting axis of rotation oriented orthogonally to the mounting surface, about which mounting axis the linking arrangement (12) can be rotated from the linking position (24) into a mounting position (25), wherein the locking device is arranged at a distance from the connecting element (18), so that the locking device can be brought into engagement with a second hole (8) of the holes (8) of the mounting limb (7) when the linking arrangement (12) is in the mounting position (25), wherein the base body further has
a top wall (15),
a first side wall (16), and
a second side wall (16),
wherein the first side wall (16) and the second side wall (16) are arranged so as to be located opposite one another and extend from the base wall (14) at least to the top wall (15), and wherein an upper side of the base wall (14) is directed towards the top wall (15), and a bottom side of the base wall (14) provides the mounting surface.

2. (canceled)

3: The linking arrangement (12) according to claim 1, wherein the base body has a plurality of support walls (17), which are arranged between the first side wall (16) and the second side wall (16) and extend from the base wall (14) to the top wall (15).

4: The linking arrangement (12) according to claim 1, wherein the base body has a rear wall, which extends from the base wall (14) at least to the top wall (15) and from the first side wall (16) to the second side wall (16).

5: The linking arrangement (12) according to claim 1, wherein the base body is formed of a plastic material.

6: The linking arrangement (12) according to claim 1, wherein the connecting element (18) comprises a plug having a hammer-shaped head and protruding from the mounting surface at an end protruding from the mounting surface, wherein the hammer-shaped head, in the linking position (24) of the linking arrangement (12), can be passed through the first hole (8) of the mounting limb (7) and, in the mounting position (25) of the linking arrangement (12), engages behind an edge region of the first hole (8) of the mounting limb (7).

7: The linking arrangement (12) according to claim 1, wherein the connecting element (18) comprises a stiffening insert.

8: The linking arrangement (12) according to claim 7, wherein the connecting element (18) has a recess, in which the stiffening insert is arranged and connected to the connecting element (18).

9: The linking arrangement (12) according to claim 1, wherein the locking device has a locking element (21), which is movable perpendicularly to the mounting surface, in particular away from the base body, in order to engage with the second hole (8) of the holes (8).

10: The linking arrangement (12) according to claim 9, wherein the locking element (21) is mounted on the base body so as to be rotatable, about a locking axis of rotation, between a first position and a second position and has a hammer-shaped head, which, in the first position of the locking element (21), can be passed through the second hole (8) of the holes (8) and, in the second position of the locking element (21), engages behind an edge region of the second hole (8) of the holes (8).

11: The linking arrangement (12) according to claim 9, wherein the locking element (21) is movable perpendicularly to the mounting surface and against an action of a spring force, wherein, in the mounting position (25), the locking element (21) can automatically engage with the second hole (8) of the holes (8) utilizing the spring force.

12: The linking arrangement (12) according to claim 11, wherein the base wall (14) has two slots extending from a first edge of the base wall (14) towards a second edge of the base wall (14) opposite the first edge and being spaced apart from one another, so that the base wall (14) can be bent between the slots in order to provide a spring element (20).

13: A connecting device for mounting a holder for components of a conveying device (1) for transporting unit loads (2), comprising a linking arrangement (12) and a mounting limb (7) interacting therewith, wherein the linking arrangement (12) is formed according to claim 1 and the mounting limb (7) has a plurality of holes (8) arranged at a distance from one another in a longitudinal direction of the mounting limb (7), wherein a first hole (8) of the holes (8) can interact with the connecting element (18) of the linking arrangement (12) and a second hole (8) of the holes (8) can interact with the locking element (21) of the linking arrangement (12).

14: The connecting device according to claim 13, wherein the mounting limb (7) is arranged on a frame profile (3a, 3b) of the conveying device (1).

15: The connecting device according to claim 13, wherein the mounting limb (7) is arranged on a cover (37).

16: A lateral guide holder (6) for mounting a lateral guide profile (4a, 4b) on a frame profile (3a, 3b) of a conveying device (1) for transporting unit loads (2), comprising a linking arrangement (12) and a mounting support (13), which mounting support (13) receives the lateral guide profile (4a, 4b) in a positive-locking manner and to which the lateral guide profile (4a, 4b) can fastened by means of a connecting means (22), wherein the linking arrangement (12) is formed according to claim 1.

17: The lateral guide holder (6) according to claim 16, wherein the mounting support (13) is formed in one piece with the base body of the linking arrangement (12).

18: The lateral guide holder (6) according to claim 16, wherein the mounting support (13) has an opening for receiving the connecting means (22).

19: The lateral guide holder (6) according to claim 16, wherein the connecting means (22) comprises a hammer-head screw, which can interact with a fastening groove (27b) of the lateral guide profile (4a, 4b), in order to fasten the lateral guide profile (4a, 4b) to the lateral guide holder (6).

20: A sensor holder (11) for mounting a sensor (10) on a frame profile (3a, 3b) of a conveying device (1) for transporting unit loads (2), comprising an outer housing (29) and an inner housing (30) for receiving the sensor (10) arranged in the outer housing (29), wherein the sensor holder (11) has the linking arrangement (12) according to claim 1.

21: The sensor holder (11) according to claim 20, wherein the base body of the linking arrangement (12) forms the outer housing (29).

22: The sensor holder (11) according to claim 20, wherein the inner housing (30) is pivotably mounted on the outer housing (29), wherein an inclination of the inner housing (30) is adjustable by means of an adjusting device.

23: The sensor holder (11) according to claim 20, wherein the connecting element (18) of the linking arrangement (12) has a cable channel, so that a cable of the sensor (10) can be passed through the cable channel out of the outer housing (29).

24: A cover holder (36) for mounting a cover (37) on a frame profile (3a, 3b) of a conveying device (1) for transporting unit loads (2), comprising a linking arrangement (12) and a mounting support (13), to which the frame profile (3a, 3b) can be fastened by means of a connecting means (22), wherein the linking arrangement (12) is formed according to claim 1.

25: The cover holder (36) according to claim 24, wherein the mounting support (13) is formed in one piece with the base body of the linking arrangement (12).

26: The cover holder (36) according to claim 24, wherein the mounting support (13) is connected to the base body of the linking arrangement (12) by means of a hinge connection, so that the mounting support (13) and the base body of the linking arrangement (12) can be pivoted relative to one another.

27: The cover holder (36) according to claim 24, wherein the mounting support (13) has an opening for receiving the connecting means (22).

28: The cover holder (36) according to claim 24, wherein the connecting means (22) comprises a hammer-head screw, which can interact with a fastening groove (27a) of the frame profile (3a, 3b), in order to fasten the cover holder (36) to the frame profile (3a, 3b).

29: The cover holder (36) according to claim 24, wherein the locking device of the linking arrangement (12) has a locking element (21), which is movable perpendicularly to the mounting surface, in particular away from the base body, in order to engage with the second hole (8) of the holes (8).

30: A conveying device (1) for transporting unit loads (2), comprising a plurality of frame profiles (3a, 3b), at least one conveying element (5) and a plurality of lateral guide profiles (4a, 4b), wherein a first frame profile (3a) of the frame profiles (3a, 3b) and a second frame profile (3b) of the frame profiles (3a, 3b) extend at a mutual distance in parallel with one another and in the conveying direction of the unit load (2), and wherein the conveying element (5) is arranged between the first frame profile (3a) and the second frame profile (3b) and defines a conveying plane (FE), on which the unit load (2) can be transported, and wherein a first lateral guide profile (4a) of the lateral guide profiles (4a, 4b) and a second lateral guide profile (4b) of the lateral guide profiles (4a, 4b) extend at a mutual distance in parallel with one another and in the conveying direction of the unit load (2), wherein the first lateral guide profile (4a) is mounted on the first frame profile (3a) and the second lateral guide profile (4b) is mounted on the second frame profile (3b), each by means of a plurality of lateral guide holders (6), wherein at least one lateral guide holder (6) of the lateral guide holders (6) has the linking arrangement (12) according to claim 1 and is fastened with a corresponding frame profile (3a, 3b) of the frame profiles (3a, 3b) by means of a connecting device comprising the linking arrangement (12) and a mounting limb (7) interacting therewith, wherein the mounting limb (7) has a plurality of holes (8) arranged at a distance from one another in a longitudinal direction of the mounting limb (7), wherein a first hole (8) of the holes (8) can interact with the connecting element (18) of the linking arrangement (12) and a second hole (8) of the holes (8) can interact with the locking element (21) of the linking arrangement (12).

31: The conveying device (1) according to claim 30, wherein the at least one lateral guide holder (6) of the lateral guide holders (6) comprises the linking arrangement (12) and a mounting support (13), which mounting support (13) receives the lateral guide profile (4a, 4b) in a positive-locking manner and to which the lateral guide profile (4a, 4b) can fastened by means of a connecting means (22).

32: The conveying device (1) according to claim 30, wherein the frame profiles (3a, 3b) each comprise a profile limb (26) oriented orthogonally to the conveying plane (FE), wherein the profile limb (26) has a first side facing the conveying plane (FE) and a second side facing away from the conveying plane (FE), and wherein the mounting limb (7) is arranged on the profile limb (26) so as to protrude from the second side and oriented in parallel with the conveying plane (FE).

33: The conveying device (1) according to claim 32, wherein the profile limb (26) has a plurality of mounting openings (28).

34: The conveying device (1) according to claim 30, wherein the lateral guide profiles (4a, 4b) each have a fastening groove (27b) for receiving a connecting means (22) of the lateral guide holder (6).

35: The conveying device (1) according to claim 30, wherein at least one sensor (10) is fastened to a frame profile (3a, 3b) of the frame profiles (3a, 3b) by means of a sensor holder (11) comprising an outer housing (29) and an inner housing (30) for receiving the sensor (10) arranged in the outer housing (29).

36: A conveying device (1) for transporting unit loads (2), comprising a plurality of frame profiles (3a, 3b), a cover (37) on a bottom side of the conveying device (1) and at least one conveying element (5), wherein a first frame profile (3a) of the frame profiles (3a, 3b) and a second frame profile (3b) of the frame profiles (3a, 3b) extend at a mutual distance in parallel with one another in the conveying direction of the unit load (2), and wherein the conveying element (5) is arranged between the first frame profile (3a) and the second frame profile (3b) and defines a conveying plane (FE), on which the unit load (2) can be transported, and wherein the cover (37) is arranged below the at least one conveying element (5) between the first frame profile (3a) and the second frame profile (3b) and extends in the conveying direction of the unit load (2) and is fastened to the first frame profile (3a) along a first edge section of the cover (37) by means of a plurality of cover holders (36) and to the second frame profile (3b) along a second edge section of the cover (37) by means of a plurality of cover holders (36), wherein at least one cover holder (36) of the cover holders (36) has the linking arrangement (12) according to claim 1 and is connectable to the cover (37) by means of a connecting device comprising the linking arrangement (12) and a mounting limb (7) interacting therewith, wherein the mounting limb (7) has a plurality of holes (8) arranged at a distance from one another in a longitudinal direction of the mounting limb (7), wherein a first hole (8) of the holes (8) can interact with the connecting element (18) of the linking arrangement (12) and a second hole (8) of the holes (8) can interact with the locking element (21) of the linking arrangement (12), and wherein the mounting limb (7) is arranged on a cover (37), wherein the first edge section of the cover (37) and the second edge section of the cover (37) each form the mounting limb (7).

37: The conveying device (1) according to claim 36, wherein the at least one cover holder (36) comprises the linking arrangement (12) and a mounting support (13), to which the frame profile (3a, 3b) can be fastened by means of a connecting means (22).

38: The conveying device (1) according to claim 36, wherein the frame profiles (3a, 3b) each have a cover limb oriented parallel to the conveying plane (FE), which cover limb has a fastening groove (27a).

39. (canceled)

40: A conveying device (1) for transporting unit loads (2), comprising a plurality of frame profiles (3a, 3b), at least one conveying element (5) and a plurality of lateral guide profiles (4a, 4b), wherein a first frame profile (3a) of the frame profiles (3a, 3b) and a second frame profile (3b) of the frame profiles (3a, 3b) extend at a mutual distance in parallel with one another and in the conveying direction of the unit load (2), and wherein the conveying element (5) is arranged between the first frame profile (3a) and the second frame profile (3b) and defines a conveying plane (FE), on which the unit load (2) can be transported, and wherein a first lateral guide profile (4a) of the lateral guide profiles (4a, 4b) and a second lateral guide profile (4b) of the lateral guide profiles (4a, 4b) extend at a mutual distance in parallel with one another and in the conveying direction of the unit load (2), wherein the first lateral guide profile (4a) is mounted on the first frame profile (3a) and the second lateral guide profile (4b) is mounted on the second frame profile (3b), each by means of a plurality of lateral guide holders (6), so that a conveying region is bounded laterally by the first lateral guide profile (4a) and the second lateral guide profile (4b), and wherein a sensor (10) is fastened to the first frame profile (3a) or to the first lateral guide profile (4a), which has a light source for providing an emitted light beam, wherein the first lateral guide profile (4a) has a first passage opening (38), through which the emitted light beam can be passed into the conveying region and which provides a sensor-side aperture plate for the emitted light beam.

41: The conveying device (1) according to claim 40, wherein the conveying device (1) has a light barrier, which comprises the sensor (10) and a light reflector corresponding to the sensor (10), wherein the sensor (10) has a light receiver, and the light reflector is positioned on a side of the conveying region opposite the sensor (10), such that the emitted light beam is reflectable on the light reflector, and a reflected light beam can be guided from the light reflector to the light receiver.

42: The conveying device (1) according to claim 41, wherein the second lateral guide profile (4b) has a second passage opening (38), through which the emitted light beam can be passed to the light reflector and the reflected light beam into the conveying region, and which passage opening provides a reflector-side aperture plate for the emitted light beam and/or the reflected light beam.

43: The conveying device (1) according to claim 40, wherein the sensor (10) is adjustable relative to the first passage opening (38) by means of an adjusting device, so that the passage opening (38) cuts off a part of the emitted light beam.

44: The conveying device (1) according to claim 42, wherein the light reflector is adjustable relative to the second passage opening (38) by means of a further adjusting device, so that the passage opening (38) cuts off a part of the reflected light beam.

45: The conveying device (1) according to claim 40, wherein a light axis of the emitted light beam extends offset and/or inclined with respect to a central axis of the first passage opening (38).

46: The conveying device (1) according to claim 40, wherein a light axis of the reflected light beam extends offset and/or inclined with respect to a central axis of the second passage opening (38).

47. (canceled)

48: A linking arrangement (12) of a connecting device for mounting a holder for components of a conveying device (1) for transporting unit loads (2), in particular of a lateral guide holder (6), a sensor holder (11), or a bottom cover holder, wherein the linking arrangement (12) is arrangeable on the holder and is connectable to a mounting limb (7), which has a plurality of holes (8) arranged at a distance from one another in a longitudinal direction of the mounting limb (7), wherein the linking arrangement (12) has a base body, which comprises a base wall (14), a connecting element (18), and a locking device, wherein the base wall (14) provides a mounting surface, and the connecting element (18) is arranged so as to protrude from the mounting surface and can be brought into engagement with a first hole (8) of the holes (8) when the linking arrangement (12) is in a linking position (24), wherein the connecting element (18) forms a mounting axis of rotation oriented orthogonally to the mounting surface, about which mounting axis the linking arrangement (12) can be rotated from the linking position (24) into a mounting position (25), wherein the locking device is arranged at a distance from the connecting element (18), so that the locking device can be brought into engagement with a second hole (8) of the holes (8) of the mounting limb (7) when the linking arrangement (12) is in the mounting position (25), wherein the locking device has a locking element (21), which is movable perpendicularly to the mounting surface, in particular away from the base body, in order to engage with the second hole (8) of the holes (8).
